(19) United States
(12) Patent Application Publication
(10) Pub. No.: US 2026/0092191 A1
(43) Pub. Date: Apr. 2, 2026

(54) INK SET, PRINTING APPARATUS, AND PRINTING METHOD

(71) Applicant: Koji Katsuragi, Kanagawa (JP)

(72) Inventor: Koji Katsuragi, Kanagawa (JP)

(73) Assignee: Ricoh Company, Ltd., Tokyo (JP)

(21) Appl. No.: 19/343,632

(22) Filed: Sep. 29, 2025

(30) Foreign Application Priority Data
Sep. 30, 2024 (JP) 2024-170192

(51) Int. Cl. C09D 11/40; B41J 2/14; C09B 67/08; C09D 11/037; C09D 11/102; C09D 11/12; C09D 11/322

(52) U.S. Cl. CPC C09D 11/40; B41J 2/1433; C09B 67/0013; C09D 11/037; C09D 11/102; C09D 11/12; C09D 11/322

(57) ABSTRACT

An ink set contains a black, cyan, magenta, and yellow inks, each independently containing a coloring material, a water-soluble organic solvent, a resin particle, and water, each of the black, cyan, and yellow inks containing (A) or (A) and (B), and
the magenta ink containing (B),
(A) a compound represented by Chemical Formula 1 or 2 below

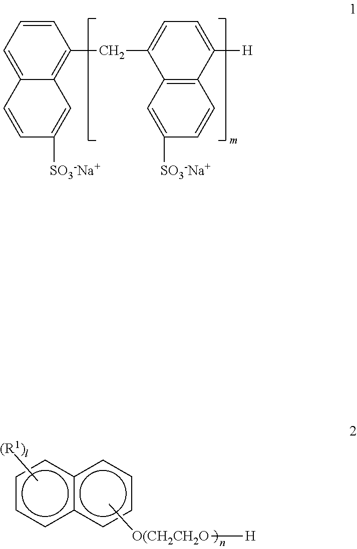

the magenta ink containing a coloring material at least partially coated with a water-insoluble resin, wherein the R/P value of the magenta ink is the largest among each ink, where R and P represent the concentration of the resin particle and the coloring material, wherein the following relationship is satisfied: 0.10≤the maximum R/P value of the cyan, magenta, and yellow ink−the minimum R/P value of the cyan, magenta and yellow ink≤0.40,
(B) the coloring material at least partially coated with a water-insoluble resin.

### CROSS-REFERENCE TO RELATED APPLICATIONS

This patent application is based on and claims priority pursuant to 35 U.S.C. § 119 to Japanese Patent Application No. 2024-170192 filed on Sep. 30, 2024 in the Japan Patent Office, the entire disclosure of which is hereby incorporated by reference herein.

### BACKGROUND

### Technical Field

The present disclosure relates to an ink set, a printing apparatus, and a printing method.

### Description of the Related Art

An ink having a content ratio of a resin emulsion to a coloring material of from 1/5 to 15/1, and a content ratio of a silicone-acrylic resin emulsion to the coloring material of from 1/20 to 5/1 has been proposed.

A recording method in which the ratio of a urethane resin to coloring materials is at least 0.10, the ratio for cyan is larger than that for yellow, the ratio for magenta is larger than that for yellow, and the content of acrylic resin in yellow is greater than the content of urethane resin in yellow has been proposed.

An ink has been proposed, wherein the product of the bubble lifetime at 150 ms and the surface tension a measured by the maximum bubble pressure method at 25 degrees Celsius has a value of 100 to 130.

### SUMMARY

The present disclosure described herein provides An ink set contains a black ink, a cyan ink, a magenta ink, and a yellow ink, each ink of the black ink, the cyan ink, the magenta ink, and the yellow ink independently containing a coloring material. a water-soluble organic solvent, a resin particle, and water,
each of the black ink, the cyan ink, and the yellow ink independently containing the following (A) or a combination of (A) and the following (B), and
the magenta ink containing (B),
(A) a compound represented by the Chemical Formula 1 below or the Chemical Formula 2 below;

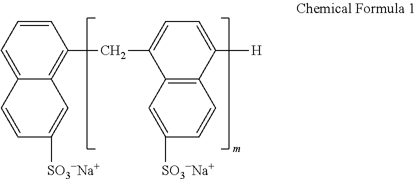

where, m represents an integer of from 1 to 4,

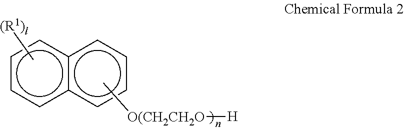

where, R¹ represents an alkyl group having 1 to 20 carbon atoms, an aralkyl group having 7 or 8 carbon atoms, or an ally group, 1 represents 0 or an integer of from 1 to 7, and n represents an integer of from 20 to 200,
(B) the coloring material including a coloring material at least partially coated with a water-insoluble resin,
wherein an R/P value of the magenta ink is the largest of the R/P value of each ink, where R represents a concentration of the resin particle in each ink and P represents a concentration of the coloring material in each ink,
wherein the following relationship is satisfied:

0.10≤the maximum R/P value of the cyan ink, the magenta ink, and the yellow ink−the minimum R/P value of the cyan ink, the magenta ink, and the yellow ink≤0.40.

According to another aspect of the present disclosure, a printing apparatus is provided which includes the ink set mentioned above and an inkjet head that includes a nozzle for discharging each ink and a nozzle plate having an ink repulsion layer containing a silicone resin or a fluororesin on the surface on an ink discharging side.

According to another aspect of the present disclosure, a printing method is provided which includes discharging each ink of the ink set mentioned above with an inkjet head including a nozzle to discharge each ink, and a nozzle plate having an ink repulsion layer containing a silicone resin or a fluororesin on the surface on an ink discharging side.

### BRIEF DESCRIPTION OF THE SEVERAL VIEWS OF THE DRAWINGS

A more complete appreciation of the disclosure and many of the attended advantages and features thereof can be readily obtained and understood from the following detailed description with reference to the accompanying drawings wherein:

FIG. 1 is a diagram illustrating a perspective view of an inkjet printing apparatus;

FIG. 2 is a schematic diagram illustrating an example of the entire configuration of an inkjet printing apparatus;

FIG. 3 is a diagram illustrating a plan view of an example of the nozzle plate in the inkjet printing apparatus;

FIG. 4 is a diagram illustrating an enlarged cross sectional view of the nozzle part of the nozzle plate in the inkjet printing apparatus; and

FIG. 5 is a diagram illustrating a state in which an ink repulsion layer is formed by applying silicon resin using a dispenser.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a”, “ ”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more the features, integers, steps, operations, elements, components, and/or groups thereof.

Embodiments of the present invention are described in detail below with reference to accompanying drawings. In describing embodiments illustrates in the drawings, specific terminology is employed for the sake of clarity. However, the disclosure of this patent specification is not intended to be limited to the specific terminology so selected. And it is to be understood that each specific element includes all technical equivalents that have a similar function, operates in a similar manner, and achieve a smaller result.

For the sake of simplicity, the same reference number will be given to identical constituent elements such as parts and materials having the same functions and redundant descriptions thereof omitted unless otherwise stated.

Within the context of the present disclosure, it a first layer is stated to be “overlaid” on, or “overlying” a second layer, the first layer may be in direct contact with a portion or all of the second layer, or there may be one or more intervening layers between the first and second layer, with the second layer being close to the substrate than the first layer.

The present disclosure described herein provides an ink set excellent in gloss uniformity and fixability on glossy paper.

The ink set contains a black ink, a cyan ink, a magenta ink, and a yellow ink, each ink of the black ink, the cyan ink, the magenta ink, and the yellow ink independently containing a coloring material. a water-soluble organic solvent, a resin particle, and water,
each of the black ink, the cyan ink, and the yellow ink independently containing the following (A) or a combination of (A) and the following (B), and
the magenta ink containing (B),
(A) a compound represented by the Chemical Formula 1 below or the Chemical Formula 2 below;

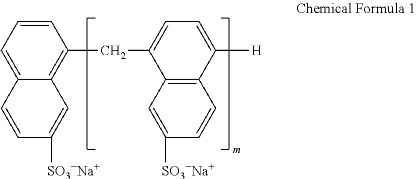

where, m represents an integer of from 1 to 4,

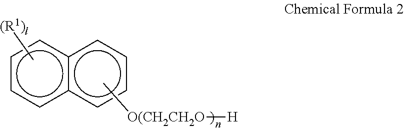

where, R¹ represents an alkyl group having 1 to 20 carbon atoms, an aralkyl group having 7 or 8 carbon atoms, or an ally group, 1 represents 0 or an integer of from 1 to 7, and n represents an integer of from 20 to 200,
(B) the coloring material including a coloring material at least partially coated with a water-insoluble resin,
wherein an R/P value of the magenta ink is the largest of the R/P value of each ink, where R represents a concentration of the resin particle in each ink and P represents a concentration of the coloring material in each ink,
wherein the following relationship is satisfied:

0.10≤the maximumR/P value of the cyan ink, the magenta ink, and the yellow ink−the minimumR/P value of the cyan ink, the magenta ink, and the yellow ink≤0.40.

### Ink

The organic solvent, water, coloring material, resin, and additive for use in the ink are described below.

### Organic Solvent

There is no specific limitation to the organic solvent for use in the present disclosure. For example, a water-soluble organic solvent can be used. It includes, but is not limited to, polyhydric alcohols, ethers such as polyhydric alcohol alkylethers and polyhydric alcohol arylethers, nitrogen-containing heterocyclic compounds, amides, amines, and sulfur-containing compounds.

Specific examples of the water-soluble organic solvent include, but are not limited to: polyhydric alcohols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, petriol, and 3-methoxy-3-methyl-1-butanol; polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylfornamide, 3-methoxy-N,N-dimethyl propioneamide, and 3-buthoxy-N,N-dimethyl propioneamide; amines such as monoethanolamine, diethanolamine, and triethylamine; sulfur-containing compounds such as dimethyl sulfoxide, sulfolane, and thiodiethanol; propylene carbonate, and ethylene carbonate.

It is preferable to use an organic solvent with a boiling point of at most 250 degrees Celsius, which serves as a humectant that dries quickly.

Polyol compounds having at least 8 carbon atoms and glycol ether compounds are also suitable. Specific examples of the polyol compounds containing at least 8 carbon atoms include, but are not limited to, 2-ethyl-1,3-hexanediol and 2,2,4-trimethyl-1,3-pentanediol.

Specific examples of the glycolether compounds include, but are not limited to, polyhydric alcohol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether and polyhydric alcohol arylethers such as ethylene glycol monophenylether and ethylene glycol monobenzylether.

A polyol compound having at least 8 carbon atoms and a glycol ether compound enhance permeability of ink for paper used as a recording medium.

The proportion of the organic solvent in the ink has no particular limit and can be suitably selected to suit to a particular application.

The proportion in the entire of the ink is preferably from 10 to 60 percent by mass and more preferably from 20 to 60 percent by mass to enhance drying property and discharging reliability of the ink.

### Water

The proportion of water in the ink is not particularly limited and can be suitably selected to suit to a particular application. It is preferably from 10 to 90 percent by mass and more preferably from 20 to 60 percent by mass to quickly dry the ink and stably discharge it.

### Coloring Material

The coloring material has no particular limitation and includes such materials as a pigment and a dye.

The pigment includes an inorganic pigment or organic pigment. These can be used alone or in combination. Mixed crystal can also be used as the coloring material. Examples of the pigments include, but are not limited to, black pigments, yellow pigments, magenta pigments, cyan pigments, white pigments, green pigments, orange pigments, and gloss or metallic pigments of gold, silver, and others.

Carbon black available from known methods such as contact methods, furnace methods, and thermal methods can be used as the inorganic pigment in addition to titanium oxide, iron oxide, calcium carbonate, barium sulfate, aluminum hydroxide, barium yellow, cadmium red, and chrome yellow.

Specific examples of the organic pigments include, but are not limited to, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye type chelates and acid dye type chelates), nitro pigments, nitroso pigments, and aniline black. Of these pigments, pigments with high affinity with solvents are preferable. Hollow resin particles and hollow inorganic particles can also be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51, C.I. Pigment Red 1, 2, 3, 5, 17, 22, 23, 31, 38, 48:2, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63, C.I. Pigment Green 1, 4, 7, 8, 10, 17, 18, and 36.

The dye is not particularly limited and includes, for example, acidic dyes, direct dyes, reactive dyes, basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

It is preferable that the coloring material of the black ink be carbon black, the coloring material of the cyan ink be Pigment Blue 15:3, the coloring material of the magenta ink be Pigment Red 122 or 269, and the coloring material of the yellow ink be Pigment Yellow 74 to provide storage stability and an expanded color gamut.

Pigment dispersion ink is obtained by, for example, preparing a self-dispersible pigment by introducing a hydrophilic functional group into a pigment, coating the surface of a pigment with a resin followed by dispersion, or using a dispersant for dispersing a pigment.

One such method of preparing a self-dispersible pigment by introducing a hydrophilic functional group into a pigment is to add a functional group such as a sulfone group and carboxyl group to a pigment (e.g., carbon) to disperse the pigment in water.

One such method of dispersing a pigment by coating the surface of the pigment with resin is to encapsulate pigment particles in microcapsules for dispersion in water. This microencapsulated pigment is also referred to as a resin-coated pigment. The resin-coated pigment particles in ink are not necessarily entirely coated with resin. Pigment particles not partially or wholly covered with resin may be dispersed in ink unless such particles have an adverse impact.

One such method of using a dispersant for dispersing a pigment is to use a known dispersant of a small or large molecular weight, typically a surfactant.

As the dispersant, a compound represented by the following Chemical Formula 1 or a compound represented by the following Chemical Formula 2 is used. An aqueous pigment dispersion or aqueous ink having an excellent storage stability and a small average particle diameter can be produced with such a dispersant.

The mass proportion of the compound represented by the following Chemical Formula 1 or Chemical Formula 2 in the ink is preferably from 0.01 to 0.5 and more preferably from 0.1 to 0.4. An ink having a proportion of a dispersant in this range preferably has a small volume average particle diameter and a suitable viscosity, which results in a good dispersibility of a pigment.

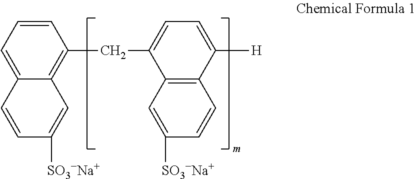

In Chemical Formula 1, m represents an integer of from 1 to 4,

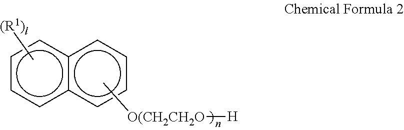

In Chemical Formula 2, R¹ represents an alkyl group having 1 to 20 carbon atoms, an aralkyl group having 7 or 8 carbon atoms, or an ally group, 1 represents 0 or an integer of from 1 to 7, and n represents an integer of from 20 to 200. Using a condensation product of naphthalene sulfonic acid and formalin as the compound represented by Chemical Formula 1 or using polyoxyethylene-β-naphthyl ether as the compound represented by Chemical Formula 2 is preferable to achieve good dispersibility.

In the ink set of the present disclosure, the black ink, the cyan ink, and the yellow ink contain the following component (A).

In contrast, if the magenta ink contains the component (A) described below, the dot surface does not become smooth, resulting in reduced gloss.

If the magenta ink does not contain a compound represented by the Chemical Formula 1 above or the Chemical Formula 2 above uses a coloring material encapsulated with a water-insoluble resin, the gloss is enhanced due to the effect of the water-insoluble resin.

Therefore, in the ink set of the present disclosure, the magenta ink does not contain the component (A) but is configured to contain the component (B). Further, the black ink, the cyan ink, and the yellow ink may also contain the compound (B) as a component.
(A) A compound represented by the Chemical Formula 1 below or the Chemical Formula 2 below
(B) A coloring material at least partially coated with a water-insoluble resin

### Fluorescent Brightener

Fluorescent brighteners, also referred to as fluorescent dyes, absorb ultraviolet on the short wavelength side of invisible light and turns it into visible light ranging from violet to blue. They increase the image density for better visibility.

Specific examples of the fluorescent brightener include, but are not limited to, those having a structural unit represented by the following Chemical Structure 1 or 2.

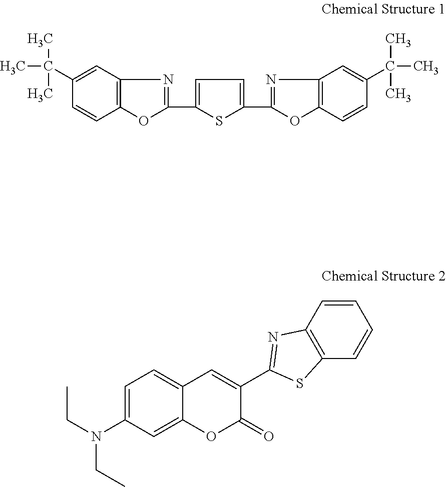

The brightener having the structural unit represented by Chemical Formula 1 illustrated above is benzooxazole or its derivative. The brightener having the structural unit represented by the Chemical Formula 2 illustrated above is benzooxazole coumarin or its derivative. They can be hydrophilic or hydrophobic.

The proportion of the fluorescent brightener in the ink is preferably from 0.001 to 1 percent by mass and more preferably from 0.005 to 0.2 percent by mass. A proportion of the fluorescent brightener of at least 0.001 percent by mass visually increases the image density. Conversely, a proportion of at most 1 percent by mass diminishes the density quenching phenomenon in which incident light is quickly absorbed or the fluorescence intensity decreases due to collision between molecules.

Specific examples of the fluorescent brightener include, but are not limited to, TINOPAL OB (available from BASF Corporation), NIKKAFLUOR OB and NIKKABRIGHT PAW-L, and NIKKAFLUOR MCT (available from Nippon Chemical Industrial CO., LTD.).

### Fluorescent Brightening Enhancer

In the present disclosure, a combinational use of a fluorescent brightening enhancers and a fluorescent brightener is suitable to improve the effect of the fluorescent brightener. Fluorescent brightening enhancers improve the dispersibility of fluorescent brighteners and enhance the effect of the fluorescent brightener by surface migration. A specific example is polyether polyol.

The ratio of the fluorescent brightening enhancer to the coloring material in the ink is preferably at 0.002:1 to 0.02:1 and more preferably from 0.005:1 to 0.02:1. A ratio of the fluorescent brightening enhancer to the coloring material at least at 0.002:1 can visually increase the image density. Conversely, a ratio of at most 0.02:1 improves the discharging stability.

A specific example of the procurable fluorescent brightening enhancer is Optiact I-10 (available from San Nopco Ltd.).

### Pigment Dispersion

Ink can be obtained by mixing a pigment with materials such as water and an organic solvent. It is also possible to mix a pigment with water, a dispersant, and other substances to prepare a pigment dispersion and thereafter mix the pigment dispersion with materials such as water and an organic solvent to manufacture ink.

The particle size of this pigment dispersion is adjusted by mixing or dispersing with water, a pigment, a pigment dispersant, and other optional components. It is good to use a dispersing device for dispersion.

The particle diameter of the pigment in the pigment dispersion has no particular limit. For example, when the maximum frequency is preferably from 20 to 500 nm and more preferably from 20 to 150 nm in the maximum number conversion, dispersion stability of the pigment is enhanced and discharging stability and the image quality such as image density are also improved. The particle diameter of a pigment can be analyzed using a particle size analyzer (Nanotrac Wave-UT151, available from MicrotracBEL Corp).

The pigment content in the pigment dispersion is preferably such that, from the viewpoint of gloss uniformity on glossy paper, the difference between the largest and smallest pigment concentrations among the cyan ink, magenta ink, and yellow ink is at most 2 percent by mass, and more preferably at most 1 percent by mass.

It is preferable that the pigment dispersion be filtered with an instrument such as filter and a centrifuge to remove coarse particles followed by deaerating.

### Resin

The ink of the present disclosure preferably may contain a polyether-based urethane resin represented by the following Chemical Formula 7. Inclusion of a polyether-based urethane resin represented by Chemical Formula 7 stably disperses a pigment and enhances the storage stability in particular. The resin represented by the Chemical Formula 7 can be identified by using GC-MS and NMR.

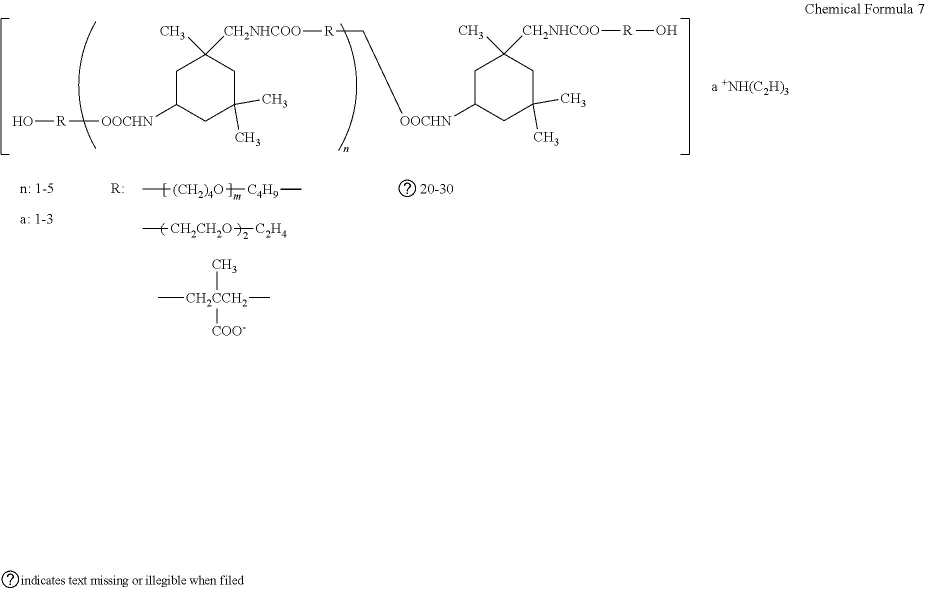

The acid value of the polyether-based urethane resin is preferably from 48 to 80 (KOHmg/g). An acid value of from 48 to 80 KOHmg/g achieves storage stability without destabilizing the dispersion of the pigment. The acid value of a resin can be measured by dissolving a measuring sample in a solution mixture of ethanol and ether, adding a phenol phthalein solution as an indicator, titrating a potassium hydroxide solution at 0.1 mol/l, and calculating the value from the amount of the potassium hydroxide solution required for titration. Polyether-based urethane resin particles can be used as the polyether-based urethane resin.

Synthetic or procured resin particles can be used. Specific examples of the procurable particles include, but are not limited to, TAKELAC™ W5661 and W932 (both available from Mitsui Chemicals, Inc.). These resins can be used alone or two or more types of the resin particles.

The ink may contain other resins. The type of the resin contained in the ink has no particular limit and can be suitably selected to suit to a particular application. It includes, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins.

Resin particles made of such resins can be also used. It is possible to obtain an ink by mixing a resin emulsion in which such resin particles are dispersed in water as a dispersion medium with materials such as a coloring material and an organic solvent. The resin particle can be synthesized or procured. These resins can be used alone or two or more types of the resin particles.

The volume average particle diameter of the resin particle is not particularly limited and can be suitably selected to suit to a particular application. The volume average particle diameter is preferably from 10 to 1,000 nm, more preferably from 10 to 200 nm, and particularly preferably from 10 to 100 nm to achieve good fixability and image robustness.

The volume average particle diameter can be measured by using a device such as a particle size analyzer (Nanotrac Wave-UT151, available from MicrotracBEL Corp.).

The proportion of the resin is not particularly limited and can be suitably selected to suit to a particular application. It is preferably from 1 to 30 percent by mass and more preferably from 5 to 20 percent by mass to the entire ink to ensure fixability and storage stability of the ink.

The particle diameter of the solid portion in the ink has no particular limit and can be suitably selected to suit to a particular application. For example, the maximum frequency in the maximum number conversion is preferably from 20 to 1,000 nm and more preferably from 20 to 150 nm to enhance the discharging stability and image quality such as optical density. The solid content includes particles such as resin particles and pigment particles. The particle diameter can be measured by using a particle size analyzer (Nanotrac Wave-UT151, available from MicrotracBEL Corp).

In order to enhance gloss uniformity and fixing property on glossy paper, when the coloring material concentration is defined as P percent by mass and the resin concentration is defined as R percent by mass in the ink, the R/P value of the magenta ink is the highest among the black, cyan, magenta, and yellow inks, and further the difference between the largest and smallest R/P values among the cyan, magenta, and yellow inks is 0.10 to 0.40.

It is preferable that the average of the R/P values of the cyan ink, magenta ink, and yellow ink be from 0.25 to 0.35.

The resin amount refers to all resins contained in the ink, including resins used for coating the coloring material and binder resins. The term “resin” refers to an organic substance having a weight average molecular weight of at least 5,000.

### Additive

The ink may further optionally include additives such as a surfactant, defoaming agent, preservative and fungicide, corrosion inhibitor, and pH regulator.

### Surfactant

The ink in the ink set of the present disclosure preferably contains a siilicone-based compound, an acetylene-based compound, and a polyoxyethylene alkyl ether-based compound.

A surfactant having a low hydrophilic lipophilic balance (HLB) value is generally added to enhance permeation or wettability to a substrate. However, a surfactant having a low HLB value is poorly dissolved in a vehicle containing water, which results in degradation of the storage stability and a problem of separation.

In the present disclosure, in order to solve the above-mentioned issues, the surfactant contains at least one of a silicon compound represented by the following Chemical Formula 3 or 4, an acetylene compound represented by the following Chemical Formula 5, and a polyoxyethylene alkyl ether compound represented by the following Chemical Formula 6. The compound represented by the Chemical Formulae 3 to 6 can be identified by using GC-MS and NMR.

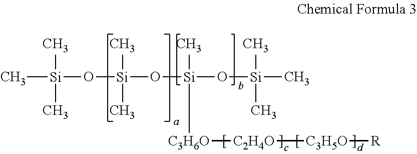

In Chemical Formula 3, a represents 0 or an integer of from 1 to 23, b represents an integer of from 1 to 10, c represents an integer of from 1 to 23, d represents 0 or an integer of from 1 to 23, and R represents a hydrogen atom or an alkyl group having 1 to 4 carbon atoms.

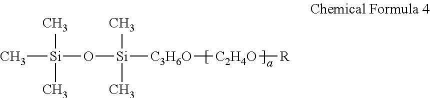

In Chemical Formula 4, a represents an integer of from 1 to 8 and R represents a hydrogen atom or an alkyl group having 1 to 4 carbon atoms.

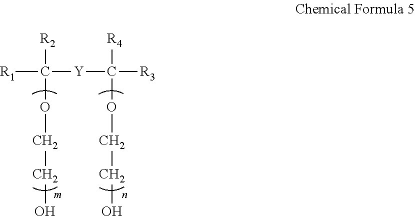

In Chemical Formula 5, R₁ to R₄ each independently represent alkyl groups, m+n represents an integer of from 1 to 20, and Y represents an acetylene group.

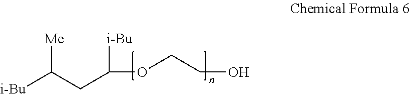

In Chemical Formula 6, n represents an integer of from 8 to 12, In the present disclosure, it is preferable to use the polysiloxane compound represented by the above Chemical Formula 3 having a low HLB and the polysiloxane compound represented by the above Chemical Formula 4 having a high HLB. Each may be used alone or in combination. In particular, when used in combination, the polysiloxane compound having a low HLB can be compatibilized with the polysiloxane compound having a high HLB, thereby maintaining wettability on the substrate while reducing separation over time.

The proportion of the silicone-based compound to the entire ink is preferably from 0.001 to 3 percent by mass and more preferably from 0.01 to 1 percent by mass. Synthetic or procured silicone-based compounds are usable.

Specific examples of the products include, but are not limited to, KF-6028 and KF-6038, both available from Shin-Etsu Chemical Co., Ltd., and SAG002 and SAG503A, both available from Nissin Chemical co., ltd. Of these, KF-6028 and SAG503A are preferable in terms of the storage stability.

In the present disclosure, the HLB of the acetylene-based compound represented by Chemical Formula 5 is preferably from 8 to 13.

An HLB of at least 8 makes it difficult to dissolve ink in a vehicle containing water, which degrades storage stability. In addition, an HLB of at most 13 may degrade the deforming property.

The proportion of the acetylene-based compound to the entire of ink is preferably from 0.1 to 3.0 percent by mass and more preferably from 0.5 to 2.0 percent by mass.

Synthetic or procured acetylene-based defoaming agents are usable. Specific examples of the procurable product include, but are not limited to, SURFYNOL 104 series, SURFYNOL 420, 440, 465, and 485, and OLFINE® PD-002W, EXP. 4001, EXP. 4200, and EXP. 4123 (all available from Nissin Chemical Industry Co., Ltd.), ACETYLENOL® E60, E100, and E200 (available from Kawaken Fine Chemicals Co., Ltd.). Of these, SURFYNOL 440 and 465 (HLB=13), OLFIN® PD-002W (HLB=9), EXP. 4001 (HLB=8), EXP. 4200 (HLB=10), and EXP. 4123 (HLB=10) are particularly preferable to achieve good defoaming property and storage stability. These can be used alone or in combination.

In the present disclosure, it is preferable to use a polyoxyethylene alkyl ether compound represented by the above Chemical Formula 6.

The content of the polyoxyethylene alkyl ether compound in the entire ink is preferably from 0.1 to 2.0 percent by mass and more preferably from 0.5 to 1.0 percent by mass. When the compound represented by the above Chemical Formula 6 is present at 0.1 or more percent by mass relative to the entire of the ink, the dots do not spread after the ink reaches the recording medium, allowing the desired image density to be obtained. On the other hand, when the content is at most 2.0 percent by mass, the surface tension does not decrease, and after discharging from an ink discharge device such as an inkjet head, the time for any ink overflowed from the nozzle to return into the nozzle is not prolonged, thereby avoiding frequent discharging misalignment.

Synthetic or procured polyoxyethylene alkyl ether-based compounds are usable. Specific examples of procurable products include, but are not limited to, TRITON® HW-1000, TMN-3, TMN-6, TMN-100X, and TMN-10 (available from Dow Chemical Company), among which TRITON® HW-1000 and TMN-6 are particularly preferable. These can be used alone or in combination.

The surfactant mentioned above can be used with other surfactants such as a fluorochemical surfactant, amphoteric surfactants, nonionic surfactants, and anionic surfactants.

The silicone-based surfactant has no specific limit and can be suitably selected to suit to a particular application.

Of these, the surfactants not decomposable in a high pH environment are preferable. Examples include, but are not limited to, side chain modified polydimethyl siloxane, both terminal-modified polydimethyl siloxane, one-terminal-modified polydimethyl siloxane, and side-chain-both-terminal-modified polydimethyl siloxane. Silicone-based surfactants having a polyoxyethylene group or a polyoxyethylene polyoxypropylene group as a modification group are particularly preferable because such an aqueous surfactant demonstrates good properties. The silicone-based surfactant includes a polyether-modified silicone-based surfactant, one of which is a compound in which a polyalkylene oxide structure is introduced into the side chain of the Si site of dimethyl silooxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not readily produce foams. Specific examples of the perfluoroalkyl sulfonic acid compounds include, but are not limited to, perfluoroalkyl sulfonic acid and salts of perfluoroalkyl sulfonic acid.

Specific examples of the perfluoroalkyl carbonic acid compounds include, but are not limited to, perfluoroalkyl carbonic acid and salts of perfluoroalkyl carbonic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain. Counter ions of salts in these fluorochemical surfactants are, for example, Li, Na, K, NH₄, NH₃CH₂CH₂OH, NH₂(CH₂CH₂OH)₂, and NH(CH₂CH₂OH)₃. Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

### Defoaming Agent

The defoaming agent has no particular limit. Examples include, but are not limited to silicon-based defoaming agents, polyether-based defoaming agents, and aliphatic acid ester-based defoaming agents. These can be used alone or in combination. Of these, silicone-based defoaming agents are preferable to enhance the ability of braking foams.

### Preservatives and Fungicides

The preservatives and fungicides (preservative and antifungal agents) are not particularly limited. One specific example is 1,2-benzisothiazoline-3-one.

### Corrosion Inhibitor

The corrosion inhibitor has no particular limit. Specific examples include, but are not limited to, acid sulfites and sodium thiosulfates.

### pH Regulator

The pH regulator is not particularly limited as long as it can control the pH to at least 7. It includes, but is not limited to, amines such as diethanol amine and triethanol amine.

Properties of the ink are not particularly limited and they can be suitably selected to suit to a particular application. The ink preferably has properties, such as viscosity, surface tension, and pH, in the following ranges.

The ink preferably has a viscosity of from 5 to 30 mPa·s and more preferably from 5 to 25 mPa·s at 25 degrees Celsius to enhance the print density and text quality and achieve good dischargeability. Viscosity can be measured with equipment such as a rotatory viscometer, RE-80L, available from TOKI SANGYO CO., LTD. The measuring conditions are as follows:
Standard cone rotor (1° 34′×R24)
Sample liquid amount: 1.2 mL
Rate of rotations: 50 rotations per minute (rpm)
25 degrees Celsius
Measuring time: three minutes.

The surface tension of the ink is preferably at most 35 mN/m and more preferably at most 32 mN/m at 25 degrees Celsius because the ink suitably levels on a recording medium and the ink dries in a short time. The surface tension of each of cyan ink, magenta ink, and yellow ink is lower than that of black ink to minimize color bleed between the inks. The difference between black ink and the other inks is preferably at least 3.0 mN/m and more preferably from 3.0 to 7.0 mN/m.

The pH of the ink is preferably from 7 to 12 and more preferably from 8 to 11 to prevent corrosion of the metal material in contact with liquid.

### Silicone Oil

For the purpose of preventing ink from adhering to the nozzle surface of an inkjet head, a silicone oil may be added.

The silicone oil is a non-aqueous compound, and by covering the surface of the ink with the silicone oil, even if the ink adheres to the nozzle surface, it does not solidify there and can be removed by the cleaning operation of the device.

The proportion of the silicone oil to the entire ink is preferably from 0.01 to 1 percent by mass and more preferably from 0.01 to 0.5 percent by mass.

### Wax

The liquid composition (ink) for use in the present disclosure may contain wax to impart slippage to the image portion.

Of the wax, polyethylene wax or carnauba wax is preferable in terms of film forming property and slippage in particular when the liquid composition is applied to the image portion.

The wax preferably has a melting point of from 80 to 140 degrees Celsius and more preferably from 100 to 140 degrees Celsius. When the melting point is at least 80 degrees Celsius, wax does not excessively melt or coagulate, thereby maintaining the storage stability of the liquid composition. When the melting point is at most 140 degrees Celsius, wax sufficiently melts in a room temperature environment, thereby imparting slippage to the ink.

The particle diameter of the wax is preferably at least 0.01 μm and more preferably from 0.01 to 0.1 m. When the particle diameter is at least 0.01 micrometers, the wax particles tend to migrate to the surface of the liquid composition, thereby imparting slippage to the liquid composition.

As examples of the aforementioned polyethylene waxes, commercially available products include, but are not limited to, the Hitech series, manufactured by Toho Chemical Industry Co., Ltd. and the AQUACER series, manufactured by BYK.

As examples of the aforementioned carnauba waxes, commercially available products include, but are not limited to, Selosol 524 and Trasol CN (both manufactured by CHUKYO YUSHI CO., LTD.).

The proportion of the wax is preferably 0.1 to 5 percent by mass and more preferably 0.1 to 1 percent by mass.

### Printing (Recording) Medium

The printing (recording) medium for use in printing is not particularly limited. Specific examples include, but are not limited to, plain paper, glossy paper, special paper, cloth, film, transparent sheets, and printing paper for general purposes.

### Printed (Recorded) Matter

The ink printed (recorded) matter related to the present disclosure includes the printing medium and an image formed on the printing medium with the ink set of the present disclosure.

The ink printed matter is obtained by an inkjet printing (recording) device that executes an inkjet printing (recording) method.

### Printing (Recording) Apparatus

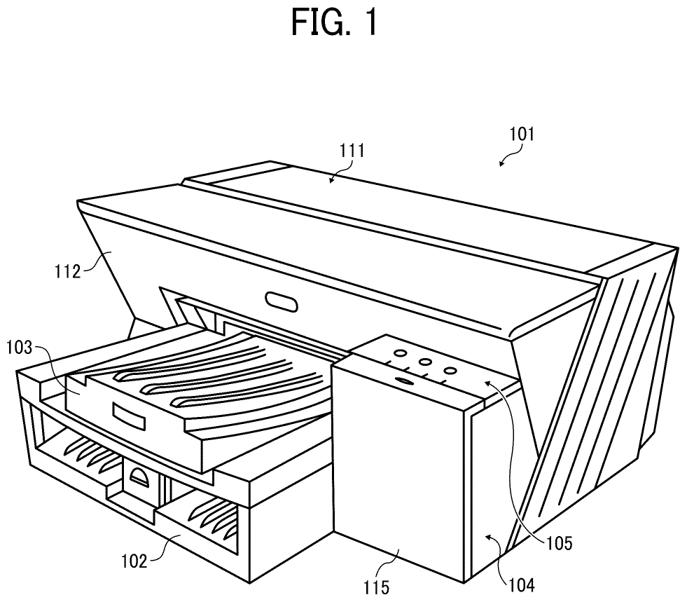

In the present disclosure, as illustrated in FIG. 1, the inkjet printing (recording) apparatus 101 includes a sheet feeder tray 102 for loading paper, and a sheet ejection tray 103 for stocking paper on which an image has been printed. The upper surface of an upper cover 111 of the inkjet printing apparatus 101 is flat. The front surface 112 of the front cover is inclined obliquely downward and backward relative to the top surface. Below this inclined front surface 112, the sheet ejection tray 103 and the sheet feeder tray 102 extend forward toward the front.

At one end portion of the front surface 112, an ink cartridge loading section 104 projects forward from the front surface 112 and is located below the upper cover 111. The ink cartridge loading section 104 is provided with a front cover 115 that can be opened and closed for attaching and detaching an ink cartridge.

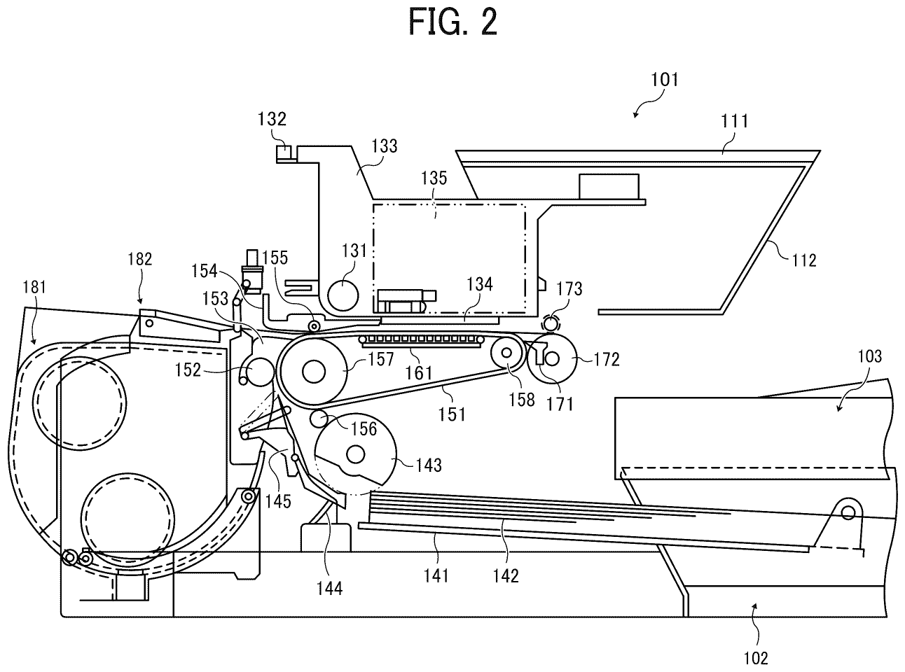

As illustrated in FIG. 2, inside the inkjet printing apparatus 101, a carriage 133 is supported slidably in the main scanning direction by a guide rod 131 and a stay 132, which are guide members horizontally bridged between the left and right side plates, and the carriage 133 is driven to move and scan by a main scanning motor.

The carriage 133 carries a printing (recording) head 134 having four inkjet heads for discharging ink droplets of each color of yellow (Y), cyan (C), magenta (M), and black (K) while multiple ink discharging orifices are arranged in the direction crossing the main scanning direction with the ink droplet discharging direction downward.

As the inkjet heads constituting the recording head 134, devices equipped with an actuator for generating energy to discharge ink may be used, such as a piezoelectric actuator using a piezoelectric element, a thermal actuator utilizing a phase change caused by film boiling of liquid with an electrothermal conversion element such as a heating resistor, a shape-memory alloy actuator employing a metal phase change induced by temperature variation, and an electrostatic actuator utilizing electrostatic force.

The carriage 133 has sub tanks 135 as containers of each color for supplying each color ink to the recording head 134. The ink is supplied and replenished to the sub-tanks 135 from an ink cartridge mounted onto the ink cartridge loading section 104 via an ink supplying tube.

Meanwhile, as a sheet feeding unit for feeding the sheet 142 stacked on the sheet loader 141 of the sheet feeder tray 102, a semi-circular roller (sheet feeding roller) 143 for separating and feeding the sheet 142 one by one from the sheet loader 141, and a separation pad 144 disposed opposite the sheet feeding roller 143, made of a material having a high friction coefficient and biased toward the sheet feeding roller 143.

A conveyance unit for conveying the sheet 142 fed from the sheet feeding unit to the lower side of the recording head 134 includes: a conveyor belt 151 for electrostatically adsorbing and conveying the sheet 142; a counter roller 152 that conveys the sheet 142 fed via the guide 145, while pinching the sheet 142 between itself and the conveyor belt 151; a conveying guide 153 for deflecting the sheet 142 conveyed vertically upward by 90 degrees and aligning the sheet onto the conveyor belt 151; and a leading-end pressing roller 155 biased toward the conveyor belt 151 by a pressing member 154. In addition, a charging roller 156 as a charger is disposed to charge the surface of the conveyor belt 151.

The conveyor belt 151 is an endless belt, stretched between a conveying roller 157 and a tension roller 158, and configured to circulate in the belt conveying direction.

The conveyor belt 151 is provided, for example, with a surface layer serving as a medium-attracting surface, formed of a resin material of about 40 μm thickness, such as pure ETFE material without resistance control, and a back layer (ground layer) formed of the same material and subjected to resistance control by carbon.

Further, a guide member 161 is disposed on the rear side of the conveyor belt 151 in correspondence with the recording region of the recording head 134.

Furthermore, the sheet ejection unit for ejecting the sheet 142 on which an image is recorded by the recording head 134 is provided with a separation claw 171 for separating the sheet 142 from the conveyor belt 151, an ejection roller 172, and an ejection roller 173. The sheet ejection tray 103 is located below the ejection roller 172.

The recording sheet electrostatically attracted to the conveyor belt 151 is ejected while being pressed from above by the ejection roller 173. Basically, the conveyor belt 151 and the ejection roller 172 convey recording sheets. The ejection roller 173 assists minimizing floating of the sheets in a printer of the present embodiment.

Therefore, the inkjet printer mentioned above can successfully minimize the number of rollers in comparison with a typical printer, thereby reducing the number of stains and scratches on recorded images.

A duplex sheet feeding unit 181 is mounted in a detachable and attachable manner onto the rear portion of the inkjet printing apparatus 101. The duplex sheet feeding unit 181 takes in the sheet 142 returned by the reverse rotation of the conveyor belt 151, reverses the sheet 142, and feeds it again between the counter roller 152 and the conveyor belt 151. A bypass sheet feeding unit 182 is provided on the upper surface of the duplex sheet feeding unit 181.

In duplex printing, the sheet 142 is conveyed to the duplex sheet feeding unit 181 immediately after printing on one side, and is reversed therein without delay. Since the ink according to the present disclosure exhibits high penetrability into the recording medium and low water content, evaporation occurs rapidly. Accordingly, duplex printing can be performed without smearing the recorded image without providing a drying time or a drying device such as a heater.

In the inkjet recording apparatus configured as described above, the recording medium 142 is separated and fed one by one from the sheet feeding unit, conveyed vertically upward, guided by the guide 145, sandwiched between the conveyor belt 151 and the counter roller 152, further guided at the leading edge by the conveying guide 153, pressed against the conveyor belt 151 by the leading-end pressing roller 155, and deflected by 90 degrees in the conveying direction.

At this time, the conveyor belt 151 is charged by the charging roller 156, and the recording medium 142 is electrostatically attracted to the conveyor belt 151 and conveyed. Then the carriage 133 is moved and the recording head 134 is driven in accordance with image signals, ink droplets are discharged onto the sheet 142 at rest to record one line, and the next line is recorded after the sheet 142 is conveyed by a predetermined amount. Upon receiving a recording end signal or a signal indicating that a trailing edge of the sheet 142 has reached the recording region, the recording operation is terminated, and the sheet 142 is ejected onto the sheet ejection tray 103.

An AC bias is applied to the charging belt to alternately charge the conveyor belt 151 with positive and negative charges at a predetermined pitch, and the sheet 142 is electrostatically attracted to the conveyor belt 151 by an electrostatic force generated by intermittently occurring micro-electric fields. A preferable range of the AC bias is ±1.2 kV to ±2.6 kV, and more preferably ±1.6 kV to ±2.4 kV. If the AC bias is below the lower limit, sufficient attraction force cannot be obtained, whereas if it exceeds the upper limit, fine droplets generated when ink is discharged from the nozzles are influenced by the charges, fail to land on the recording medium, and instead scatter back to contaminate the periphery of the head. The influence of the charge on the fine droplets is related to electrical properties of the ink. As the electric conductivity of ink increases, the droplets discharged are subject to charges. Reducing the conductivity is preferable.

When a near-end state of the ink remaining in the sub-tank 135 is detected, a predetermined amount of ink is replenished from the ink cartridge into the sub-tank 135.

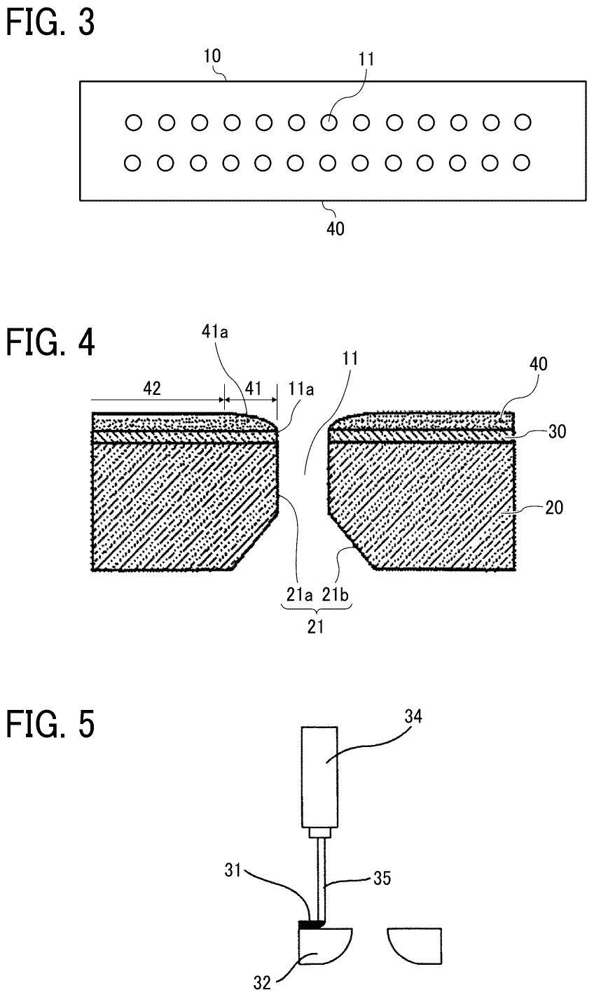

FIG. 3 is a plan view schematically illustrating an example of a nozzle plate in the inkjet printing apparatus of the present disclosure.

The nozzle plate employed in the present disclosure will be described with reference to FIGS. 3 and 4.

FIG. 4 is an enlarged sectional view illustrating a single nozzle portion.

A nozzle plate 10 includes a nozzle substrate 20 in which apertures 21 serving as nozzles 11 for discharging liquid (hereinafter also referred to simply as “nozzles”) are formed. The nozzle plate 10 further includes an intermediate layer 30 formed on the surface of the nozzle substrate 20, and an ink repulsion layer 40 formed on the liquid discharge surface side.

The nozzle substrate 20 is made of, for example, a metal plate member. The nozzle substrate 20 uses a stainless steel metal plate member, but is not limited thereto.

The nozzle 11 includes a cylindrical part 21a on the liquid discharging surface side and a truncated conical member 21b on the surface opposite to the liquid discharging surface.

The intermediate layer 30 includes one or more layers such as, for example, an SiO₂ layer or a silane coupling agent layer serving as an underlying layer. The intermediate layer 30 may be omitted.

The ink repulsion layer 40 contains silicon resin.

The ink repulsion layer 40 includes an inclined region 41 in which an inclined surface 41a is formed to slope toward an edge 11a of the nozzle 11, whereby the film thickness decreases toward the nozzle edge. In a region 42 of the ink repulsion layer 40 other than the inclined region 41, the film thickness is substantially constant and flat. The inclined surface 41a of the inclined region 41 may be linear or curved in cross section.

The average film thickness of the surface of the ink repulsion layer 40 on the ink discharging side is preferably 1 to 3 m.

The intermediate layer 30 is preferably a silane coupling agent layer having an amino group as the underlying layer of the ink repulsion layer 40. The intermediate layer 30 and the ink repulsion layer 40 are firmly attached through interaction between the amino group and the ink-repellent material, thereby providing strong adhesion.

### Method of Manufacturing Nozzle Member of Inkjet Head

FIG. 5 illustrates a configuration in which an ink repulsion layer 31 is formed on the surface of the nozzle plate 32 by applying a silicone resin using a dispenser 34 according to the present embodiment.

The dispenser 34 is disposed for applying a silicone solution to the liquid discharge surface of the nozzle plate 32, the nozzle plate 32 being formed by Ni electroforming. During a scanning operation of the dispenser 34, silicone resin is discharged from the tip of a needle 35 while maintaining a predetermined constant distance between the nozzle plate 32 and the tip of the needle 35. As a result, a silicone resin film is selectively formed on the liquid discharge surface of the nozzle plate 32.

In the present embodiment, as the silicone resin, room-temperature curable silicon resin SR2411 (available from Dow Corning Toray Co., Ltd.) was used. At the time, slight wraparound of silicone onto the nozzle holes and the rear surface of the nozzle plate was observed. The thickness of the selectively formed silicone resin coating was 1.2 μm, and the surface roughness (Ra) was 0.18 μm.

The ink repulsion layer 31 can be formed of any material that repels ink. One specific example thereof is a silicone-based water-repellent material.

Preferred examples of the silicone-based water-repellent materials include, but are not limited to, liquid silicone resins or elastomers that are curable at room temperature, which are applied onto the surface of the substrate and polymerized and cured by leaving them in the atmosphere at room temperature, thereby forming an ink-repellent film.

Alternatively, the silicon-based water-repellent material mentioned above may be a thermocuring liquid silicon resin or elastomer. The material can be applied to the surface of a substrate followed by heating to cure the material, resulting in forming an ink repulsion film.

Alternatively, the silicon-based water-repellent material mentioned above can be an ultraviolet-curing liquid silicon resin or elastomer. The material can be applied to the surface of a substrate followed by exposure to ultraviolet to cure the material, resulting in forming an ink repulsion film.

The viscosity of the silicone-based water-repellent material is preferably at least 1000 cP.

The critical surface tension of the ink repulsion layer is preferably 5 mN/m to 40 mN/m, and more preferably 5 mN/m to 30 mN/m. A critical surface tension greater than 30 mN/m causes a problem of excessive wetting of ink on a nozzle plate over time. This excessive wetting may cause ink discharging deviation or abnormal atomization during repeated printing. At a critical surface tension greater than 40 mN/m, ink wets on a nozzle plate from the beginning, which may quickly start ink discharging deviation and abnormal atomization.

Terms such as image forming, recording, printing, and print used in the present disclosure represent the same meaning.

Also, recording (printing) media, media, and printed matter in the present disclosure have the same meaning unless otherwise specified.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight rations in parts, unless otherwise specified.

### EXAMPLES

Next, embodiments of the present disclosure are described in detail with reference to Examples and Comparative Examples but are not limited thereto. In Examples, “parts” and “percent” are “parts by mass” and “percent by mass” unless otherwise specified.

Unless otherwise specified, preparation and evaluation were conducted at a temperature of 23 degrees Celsius and a humidity of 50 percent.

### Manufacturing of Pigment Dispersion

### Preparation of Black Pigment Dispersion

Two hundred fifty parts of carbon black (available from Degussa AG), 50 parts of a compound represented by the above Chemical Formula 1 (TAKESURF A-45-K, available from Takemoto Oil & Fat Co., Ltd.), and 700 parts of distilled water were premixed to obtain a slurry mixture. The slurry mixture was subjected to circulation dispersion by a disk media mill (UMA type, available from KOTOBUKI KOGYO CO., LTD., currently Hiroshima Metal & Machinery Co., Ltd.) with a 0.015 mm zirconia bead (filing ratio of 70 percent) at a circumferential speed of 6 m/s and at a liquid temperature of 10 degrees Celsius to obtain a volume average particle diameter of about 100 nm. The coarse particles were then removed from the resulting dispersion by a centrifuge, Model-7700, available from Kubota Corporation. After the filtrate was further filtered with a filter having a pore diameter of 1.2 m, the moisture of the resulting filtrate was adjusted to obtain a black pigment liquid dispersion having a pigment concentration of 15 percent.

### Preparation of Blue Pigment Dispersion

A total of 250 parts of Pigment Blue 15:3 (available from Dainichiseika Color & Chemicals Mfg. Co., Ltd.), 50 parts of the compound represented by Chemical Formula 2 (PIONINE D-7240, available from TAKEMOTO OIL & FAT CO., LTD.), and 700 parts of distilled water were preliminarily mixed to obtain a slurry mixture. The slurry mixture was subjected to circulation dispersion by a disk media mill (UMA type, available from “KOTOBUKI KOGYO CO., LTD.) with a 0.015 mm zirconia bead (filing ratio of 70 percent) at a circumferential speed of 6 m/s and at a liquid temperature of 10 degrees Celsius to obtain a volume average particle diameter of about 100 nm. The coarse particles were then removed from the resulting dispersion by a centrifuge, Model-7700, available from Kubota Corporation. After the filtrate was further filtered with a filter having a pore diameter of 1.2 m, the moisture of the resulting filtrate was adjusted to obtain a blue pigment liquid dispersion having a pigment concentration of 15 percent.

### Preparation of Red Pigment Dispersion

A red pigment dispersion having a pigment concentration of 15 percent was obtained in the same manner as in Preparation of Blue Pigment Dispersion except that Pigment Blue 15:3 was changed to Pigment Red 122 (available from Dainichiseika Color & Chemicals Mfg. Co., Ltd.).

### Preparation of Yellow Pigment Dispersion

A yellow pigment dispersion having a pigment concentration of 15 percent was obtained in the same manner as in Preparation of Blue Pigment Dispersion except that Pigment Blue 15:3 was changed to Pigment Red 74, available from Dainichiseika Color & Chemicals Mfg. Co., Ltd.

### Preparation of Styrene-Acrylic-based Resin Coated Pigment Dispersion Preparation of Resin Coated Black Pigment Dispersion

A total of 11.2 g of styrene, 2.8 g of acrylic acid, 12 g of lauryl methacrylate, 4 g of polyethylene glycol methacrylate, 4 g of styrene macromer, and 0.4 g of mercapto ethanol were mixed in a flask followed by heating to 65 degrees Celsius. Subsequently, a liquid mixture of 100.8 g of styrene, 25.2 g of acrylic acid, 108 g of lauryl methacrylate, 36.2 g of polyethylene glycol methacrylate, 60 g of hydroxyethyl methacrylate, 36 g of styrene macromer, 3.6 g of mercapto ethanol, 2.4 g of azobismethyl valeronitrile, and 18 g of methylethyl ketone was added dropwise to the flask in two and a half hours. After the dropwise addition, a liquid mixture of 0.8 g of azobismethyl valeronitrile and 18 g of methylethyl ketone was added dropwise to the flask in half an hour. The resulting mixture was aged at 65 degrees Celsius for one hour. Thereafter, 0.8 g of azobismethyl valeronitrile was added followed by aging for another hour. After the reaction was complete, 364 g of methylethyl ketone was added to the flask to obtain 800 g of a polymer solution having a solids content of 50 percent.

Thereafter, 25 g of the polymer solution, 50 g of carbon black (available from Cabot Corporation), 13.6 g of 1 mol/L aqueous potassium hydroxide solution, 20 g of methylethyl ketone, and 13.6 g of water were sufficiently stirred followed by mixing and kneading with a roll mill. The paste obtained was introduced into 200 g of pure water followed by sufficient stirring. Methylethyl ketone was then removed with an evaporator followed by pressure-filtering with a polyvinylidene fluoride membrane filter having an average pore diameter of 5 m. The moisture of the filtrate was adjusted to obtain a dispersion of styrene-acrylic-based resin-coated black pigment having a solids concentration of 20 percent (pigment concentration of 15 percent and coated resin concentration of 5 percent).

### Preparation of Resin Coated Blue Pigment Dispersion

A styrene-acrylic resin coated blue pigment dispersion having a solids concentration of 20 percent (pigment concentration of 15 percent and coated resin concentration of 5 percent) was obtained in the same manner as in Preparation of Resin Coated Black Pigment Dispersion except that carbon black was changed to Pigment Blue 15:3, available from Dainichiseika Color & Chemicals Mfg. Co., Ltd.

### Preparation of Resin Coated Red Pigment Dispersion

A styrene-acrylic resin coated red pigment dispersion having a solids concentration of 20 percent (pigment concentration of 15 percent and coated resin concentration of 5 percent) was obtained in the same manner as in Preparation of Resin Coate Black Pigment Dispersion except that carbon black was changed to Pigment Red 122, available from Dainichiseika Color & Chemicals Mfg. Co., Ltd.

### Preparation of Resin Coated Yellow Pigment Dispersion

A styrene-acrylic resin coated yellow pigment dispersion having a solids concentration of 20 percent (pigment concentration of 15 percent and coated resin concentration of 5 percent) was obtained in the same manner as in Preparation of Resin Coated Black Pigment Dispersion except that carbon black was changed to Pigment Yellow 74, available from Dainichiseika Color & Chemicals Mfg. Co., Ltd.

### Synthesis of Aqueous Polyurethane Resin Dispersion

Into a four-necked flask equipped with a stirrer, Dimroth condenser, nitrogen inlet tube, silica gel drying tube, and thermometer, 119.70 g of 3-isocyanatomethyl-3,5,5-trimethylcyclohexyl isocyanate as the polyisocyanate component, 60.90 g of dimethylolpropionic acid, 60.40 g of bisphenoxyethanolfluorene (manufactured by Osaka Gas Chemicals Co., Ltd.), and 13.37 g of polytetramethylene glycol having a number-average molecular weight of 2000 as active hydrogen components, and 300.00 g of methyl ethyl ketone as solvent were added.

The mixture was stirred for 12 hours at 80 degrees Celsius under a nitrogen atmosphere.

Upon confirming disappearance of the isocyanate absorption band by infrared spectroscopy, the reaction mixture was cooled to 40 degrees Celsius and 45.99 g of triethylamine was added to neutralize the reaction mixture, followed by addition of 700.00 g of water and dispersion with a homodisper. Thereafter, methyl ethyl ketone was removed under reduced pressure at 50 degrees Celsius and 6.66 kPa, thereby obtaining an aqueous polyurethane resin dispersion substantially free of solvent, having a fluorene skeleton content of 20 percent by mass, an acid value of 85 KOH mg/g, a solids concentration of 30 percent by mass, and a viscosity of 200 mPa·s.

### Preparation of Ink

The organic solvent, surfactant, other additives such as defoaming agents, pH regulators, and antibacterial agents, and deionized water shown in Tables 1 and 2 were mixed and stirred for one hour.

Next, resin particles were added followed by stirring for one hour to uniformly mix the mixture. Thereafter, each of the pigment dispersions was added to the mixture followed by stirring for one hour to uniformly mix the mixture. The thus-obtained mixture was filtered with a polyvinylidene fluoride membrane filter having an average opening diameter of 0.8 μm under pressure to remove coarse particles and dust. Ink was thus obtained.

### Resin Particle

Polyether-based urethane resin particle A, TAKELAC W5661, acid value of 48 KOHmg/g, available from Mitsui Chemicals, Inc.

### Compound Represented by Chemical Formula 7

Polyether-based urethane resin particle B, TAKELAC W932, acid value of 80 KOHmg/g, available from Mitsui Chemicals, Inc.

### Compound Represented by Chemical Formula 7

Polyether-based urethane resin particle C, synthetic: acid value of 85 KOHmg/g

### Surfactant

Silicone-based surfactant A, KF-6028, available from Shin-Etsu Chemical Co., Ltd.

### Compound Represented by Chemical Formula 3

Silicone-based surfactant B, SAG503A, available from Nissin Chemical co., ltd.

### Compound Represented by Chemical Formula 4

SURFYNOL 440: acetylene-based surfactant (available from Nisshin Chemical Co., Ltd.)
   Compound represented by Chemical Formula 5
Polyoxyethylene alkyl ether-based surfactant, TRITON, HW-1000, available from Dow Chemical Corporation

### Compound Represented by Chemical Formula 6

Fluorochemical surfactant, PF 656, available from OMNOVA-Chemie GmbH

### Organic Solvent

Organic solvent A (glycerin, available from Sakamoto Yakuhin Kogyo Co., Ltd.)
Organic solvent B (1,3-butylene glycol, available from Tokyo Chemical Industry Co., Ltd.)

### Silicone Oil

Polyether modified silicone compound (KF353, available from Shin-Etsu Chemical Co., Ltd.)

### Wax

Polyethylene-based wax emulsion (HYTEC AQUACER-539 available from By BYK)

### Printing Method

Black (Example K-1), Cyan (Example C-1), and Yellow (Example Y-1) inks shown in Tables 1 and 2, together with various magenta inks (Examples M-1 to M-16 and Comparative Examples M-1 to M-4), were printed at a resolution of 1200×1200 dpi onto a recording medium (Sakura Paper Co., Ltd., Star Glossy Photo 3) using an image forming apparatus (SG5200, manufactured by Ricoh Company, Ltd.) equipped with a nozzle plate having an ink repulsion layer formed of a silicone resin (room-temperature curable silicone resin SR2411, manufactured by Toray Dow Corning Co., Ltd.). The printed matter was then dried for 24 hours at room temperature to obtain print samples. As the print chart, solid black images and solid color images of 2 cm square were employed. The solid black image included both an image printed with black ink alone and a composite black image printed using the respective color inks.

### 60 Degrees Gloss Evaluation

The glossiness of the solid images of the print samples was measured within the solid image area using a gloss meter (Micro-Gloss 60, manufactured by BYK), and evaluation was carried out according to the following criteria. If the rating is S, A, or B, it can be used at a practical level.

### Evaluation Criteria

S: 70 or greater
A: 60 to less than 70
B: 50 to less than 60
C: Less than 50

### Gloss Uniformity

In the present disclosure, gloss uniformity is evaluated based on the gloss difference among the solid areas of composite black formed with cyan/magenta/yellow, cyan, magenta, and yellow. The evaluation method is as follows.

The glossiness of the solid images of composite black formed with cyan/magenta/yellow, cyan, magenta, and yellow was measured within the solid images using a gloss meter (Micro-Gloss 60, manufactured by BYK). The gloss difference between individual colors (maximum gloss value−minimum gloss value) was calculated, and judgment was made according to the evaluation criteria below. Further, for each color, the gloss value was obtained as the average of measurements taken at multiple locations (five points) within the solid image.

If the rating is A or B, it can be used at a practical level.

### Evaluation Criteria

A: Less than 30
B: 30 to less than 50
C: 50 or higher

### Evaluation on Fixability

Using a rubbing apparatus fitted with a cotton cloth (Clock meter, available from DAIEI KAGAKU SEIKI MFG. co., ltd.), the solid image area of the print sample was rubbed back and forth five times. The density of the ink transferred onto the cotton cloth was then measured with an image measuring device (Exact, manufactured by X-Rite), and the evaluation was conducted based on the criteria shown below. If the rating is S, A, or B, it can be used at a practical level.

### Evaluation Criteria

S: less than 0.05
A: 0.05 to less than 0.10
B: 0.10 to less than 0.20
C: 0.20 or higher

### Evaluation on Image Density

The image density of the solid images of the print sample was measured using an image measuring device (Exact, available from X-Rite Inc.), and the evaluation was conducted based on the criteria shown below. If the rating is S, A, or B, it can be used at a practical level.

### Evaluation Criteria

S: 2.0 or greater
A: 1.8 to less than 2.0
B: 1.6 to less than 1.8
C: Less than 1.6

### Measuring on Surface Tension of Ink

The automatic surface tension of the ink was measured with a static surface tensiometer (DY-300, available from Kyowa Interface Science Co., Ltd.).

TABLE 1

| | | K | C | Y |
|---|---|---|---|---|
| | | Example | Example | Example |
| | | K-1 | C-1 | Y-1 |
| Pigment dispersion | Black pigment | 26.7 | | |
| (pigment solids | dispersion | | | |
| content = 15 | (dispersant: | | | |
| percent) | compound of | | | |
| | Chemical | | | |
| | Formula 1) | | | |
| | Blue pigment | | 13.3 | |
| | dispersion | | | |
| | (dispersant: | | | |
| | compound of | | | |
| | Chemical | | | |
| | Formula 2) | | | |
| | Red pigment | | | |
| | dispersion | | | |
| | (dispersant: | | | |
| | compound of | | | |
| | Chemical | | | |
| | Formula 2) | | | |
| | Yellow | | | 13.3 |
| | pigment | | | |
| | dispersion | | | |
| | (dispersant: | | | |
| | compound of | | | |
| | Chemical | | | |
| | Formula 2) | | | |
| Resin-coated | Resin coated | 26.7 | | |
| pigment dispersion | black pigment | | | |
| (pigment solids | dispersion | | | |
| content = 15 | Resin coated | | 20.0 | |
| percent) | blue pigment | | | |
| | dispersion | | | |
| | Resin coated | | | |
| | red pigment | | | |
| | dispersion | | | |
| | Resin coated | | | 20.0 |
| | yellow pigment | | | |
| | dispersion | | | |
| Coating resin | Styrene acrylic | 1.8 | 0.2 | 0.2 |
| | resin | | | |
| Resin particle | Polyether | | 0.9 | 0.9 |
| | urethane resin | | | |
| | fine particle A | | | |
| | (compound of | | | |
| | Chemical | | | |
| | Formula 7) | | | |
| | Polyether | 0.5 | | |
| | urethane resin | | | |
| | fine particle B | | | |
| | (compound of | | | |
| | Chemical | | | |
| | Formula 7) | | | |
| | Polyether | | | |
| | urethane resin | | | |
| | fine particle C | | | |
| Surfactant | Silicone-based | 0.05 | 0.1 | 0.1 |
| | surfactant A | | | |
| | (Chemical | | | |
| | Formula 3) | | | |
| | Silicone-based | | | |
| | surfactant B | | | |
| | (Chemical | | | |
| | Formula 4) | | | |
| | Acetylene- | | | |
| | based | | | |
| | surfactant | | | |
| | (Chemical | | | |
| | Formula 5) | | | |
| | Alkyl-based | | | |
| | surfactant | | | |
| | (Chemical | | | |
| | Formula 6) | | | |
| | Fluorochemical | | | |
| | (fluororesin) | | | |
| | surfactant | | | |
| Organic solvent | Organic | 20.0 | 20.0 | 20.0 |
| | solvent A | | | |
| | Organic | 15.0 | 15.0 | 15.0 |
| | solvent B | | | |
| Silicone oil | Polyether- | | | |
| | modified | | | |
| | silicone oil | | | |
| Wax | Polyethylene | | | |
| | wax | | | |
| Defoaming agent | 2,4,7,9- | 0.5 | 0.5 | 0.5 |
| | tetramethyl | | | |
| | decane-4,7-diol | | | |
| pH regulator | 2-amino-2- | 0.5 | 0.5 | 0.5 |
| | ethyl-1,3- | | | |
| | propane diol | | | |
| Antibacterial agent | LV(S) | 0.1 | 0.1 | 0.1 |
| Water | Deionized | Balance | Balance | Balance |
| | water | | | |
| Total | | 100.0 | 100.0 | 100.0 |
| Ink formulation | Concentration | 8.0 | 5.0 | 5.0 |
| | of coloring | | | |
| | material | | | |
| Ink properties | Surface tension | 31.4 | 28.4 | 28.4 |
| | (mN/m) | | | |
| Ink property values | R/P | 0.29 | 0.23 | 0.22 |
| Image quality | Single color | — | — | — |
| | (60 degrees | | | |
| | gloss) | | | |
| | Gloss | — | — | — |
| | uniformity | | | |
| | Single color | — | — | — |
| | (fixability) | | | |
| | Single color | — | — | — |
| | (image density) | | | |
| Other property | R/P value | — | — | — |
| values | difference | | | |
| | among CMY | | | |
| | (maximum − | | | |
| | minimum) | | | |
| | Pig | — | — | — |
| | concentration | | | |
| | difference | | | |
| | among CMY | | | |
| | R/P value | — | — | — |
| | average | | | |
| | amount CMY | | | |
| | Surface tension | — | — | — |
| | difference | | | |
| | (minimum γ of | | | |
| | colors − γ of | | | |
| | black) | | | |

| | | M | M | M | M |
|---|---|---|---|---|---|
| | | Comparative | Comparative | Comparative | Comparative |
| | | Example | Example | Example | Example |
| | | M-1 | M-2 | M-3 | M-4 |
| Pigment | Black pigment | | | | |
| dispersion | dispersion | | | | |
| (pigment | (dispersant: | | | | |
| solids | compound of | | | | |
| content = 15 | Chemical Formula | | | | |
| percent) | 1) | | | | |
| | Blue pigment | | | | |
| | dispersion | | | | |
| | (dispersant: | | | | |
| | compound of | | | | |
| | Chemical Formula | | | | |
| | 2) | | | | |
| | Red pigment | 46.7 | 23.3 | | |
| | dispersion | | | | |
| | (dispersant: | | | | |
| | compound of | | | | |
| | Chemical Formula | | | | |
| | 2) | | | | |
| | Yellow pigment | | | | |
| | dispersion | | | | |
| | (dispersant: | | | | |
| | compound of | | | | |
| | Chemical Formula | | | | |
| | 2) | | | | |
| Resin-coated | Resin coated black | | | | |
| pigment | pigment dispersion | | | | |
| dispersion | Resin coated blue | | | | |
| (pigment | pigment dispersion | | | | |
| solids | Resin coated red | | 23.3 | 46.7 | 46.7 |
| content = 15 | pigment dispersion | | | | |
| percent) | Resin coated yellow | | | | |
| | pigment dispersion | | | | |
| Coating resin | Styrene acrylic resin | | 0.3 | 0.5 | 0.5 |
| Resin | Polyether urethane | 1.0 | 1.0 | 1.0 | 4.0 |
| particle | resin fine particle A | | | | |
| | (compound of | | | | |
| | Chemical Formula | | | | |
| | 7) | | | | |
| | Polyether urethane | | | | |
| | resin fine particle B | | | | |
| | (compound of | | | | |
| | Chemical Formula | | | | |
| | 7) | | | | |
| | Polyether urethane | | | | |
| | resin fine particle C | | | | |
| Surfactant | Silicone-based | 0.1 | 0.1 | 0.1 | 0.1 |
| | surfactant A | | | | |
| | (Chemical Formula | | | | |
| | 3) | | | | |
| | Silicone-based | | | | |
| | surfactant B | | | | |
| | (Chemical Formula | | | | |
| | 4) | | | | |
| | Acetylene-based | | | | |
| | surfactant | | | | |
| | (Chemical Formula | | | | |
| | 5) | | | | |
| | Alkyl-based | | | | |
| | surfactant | | | | |
| | (Chemical Formula | | | | |
| | 6) | | | | |
| | Fluorochemical | | | | |
| | (fluororesin) | | | | |
| | surfactant | | | | |
| Organic | Organic solvent A | 20.0 | 20.0 | 20.0 | 20.0 |
| solvent | Organic solvent B | 15.0 | 15.0 | 15.0 | 15.0 |
| Silicone oil | Polyether-modified | | | | |
| | silicone oil | | | | |
| Wax | Polyethylene wax | | | | |
| Defoaming | 2,4,7,9-tetramethyl | 0.5 | 0.5 | 0.5 | 0.5 |
| agent | decane-4,7-diol | | | | |
| pH regulator | 2-amino-2-ethyl- | 0.5 | 0.5 | 0.5 | 0.5 |
| | 1,3-propane diol | | | | |
| Antibacterial | LV(S) | 0.1 | 0.1 | 0.1 | 0.1 |
| agent | | | | | |
| Water | Deionized water | Balance | Balance | Balance | Balance |
| Total | | 100.0 | 100.0 | 100.0 | 100.0 |
| Ink | Concentration of | 7.0 | 7.0 | 7.0 | 7.0 |
| formulation | coloring material | | | | |
| Ink | Surface tension | 25.5 | 25.4 | 25.7 | 26.1 |
| properties | (mN/m) | | | | |
| Ink property | R/P | 0.14 | 0.18 | 0.22 | 0.65 |
| values | | | | | |
| Image | Single color (60 | C | C | C | C |
| quality | degrees gloss) | | | | |
| | Gloss uniformity | C | C | C | C |
| | Single color | C | C | C | A |
| | (fixability) | | | | |
| | Single color (image | A | A | A | B |
| | density) | | | | |
| Other | R/P value difference | 0.08 | 0.04 | 0.01 | 0.43 |
| property | among | | | | |
| values | CMY | | | | |
| | (maximum − | | | | |
| | minimum) | | | | |
| | Pig concentration | 2.0 | 2.0 | 2.0 | 2.0 |
| | difference among | | | | |
| | CMY | | | | |
| | R/P value average | 0.19 | 0.21 | 0.22 | 0.36 |
| | amount CMY | | | | |
| | Surface tension | −5.9 | −6.0 | −5.7 | −5.3 |
| | difference | | | | |
| | (minimum γ of | | | | |
| | colors − γ of black) | | | | |

| | | M | M | M | M |
|---|---|---|---|---|---|
| | | Example | Example | Example | Example |
| | | M-1 | M-2 | M-3 | M-4 |
| Pigment | Black pigment | | | | |
| dispersion | dispersion | | | | |
| (pigment | (dispersant: | | | | |
| solids | compound of | | | | |
| content = 15 | Chemical Formula | | | | |
| percent) | 1) | | | | |
| | Blue pigment | | | | |
| | dispersion | | | | |
| | (dispersant: | | | | |
| | compound of | | | | |
| | Chemical Formula | | | | |
| | 2) | | | | |
| | Red pigment | | | | |
| | dispersion | | | | |
| | (dispersant: | | | | |
| | compound of | | | | |
| | Chemical Formula | | | | |
| | 2) | | | | |
| | Yellow pigment | | | | |
| | dispersion | | | | |
| | (dispersant: | | | | |
| | compound of | | | | |
| | Chemical Formula | | | | |
| | 2) | | | | |
| Resin-coated | Resin coated black | | | | |
| pigment | pigment dispersion | | | | |
| dispersion | Resin coated blue | | | | |
| (pigment | pigment dispersion | | | | |
| solids | Resin coated red | 46.7 | 40.0 | 33.3 | 26.7 |
| content = 15 | pigment dispersion | | | | |
| percent) | Resin coated yellow | | | | |
| | pigment dispersion | | | | |
| Coating resin | Styrene acrylic resin | 0.5 | 0.5 | 0.4 | 0.3 |
| Resin | Polyether urethane | 1.7 | 1.5 | 1.2 | 1.0 |
| particle | resin fine particle A | | | | |
| | (compound of | | | | |
| | Chemical Formula | | | | |
| | 7) | | | | |
| | Polyether urethane | | | | |
| | resin fine particle B | | | | |
| | (compound of | | | | |
| | Chemical Formula | | | | |
| | 7) | | | | |
| | Polyether urethane | | | | |
| | resin fine particle C | | | | |
| Surfactant | Silicone-based | 0.1 | 0.1 | 0.1 | 0.1 |
| | surfactant A | | | | |
| | (Chemical Formula | | | | |
| | 3) | | | | |
| | Silicone-based | | | | |
| | surfactant B | | | | |
| | (Chemical Formula | | | | |
| | 4) | | | | |
| | Acetylene-based | | | | |
| | surfactant | | | | |
| | (Chemical Formula | | | | |
| | 5) | | | | |
| | Alkyl-based | | | | |
| | surfactant | | | | |
| | (Chemical Formula | | | | |
| | 6) | | | | |
| | Fluorochemical | | | | |
| | (fluororesin) | | | | |
| | surfactant | | | | |
| Organic | Organic solvent A | 20.0 | 20.0 | 20.0 | 20.0 |
| solvent | Organic solvent B | 15.0 | 15.0 | 15.0 | 15.0 |
| Silicone oil | Polyether-modified | | | | |
| | silicone oil | | | | |
| Wax | Polyethylene wax | | | | |
| Defoaming | 2,4,7,9-tetramethyl | 0.5 | 0.5 | 0.5 | 0.5 |
| agent | decane-4,7-diol | | | | |
| pH regulator | 2-amino-2-ethyl- | 0.5 | 0.5 | 0.5 | 0.5 |
| | 1,3-propane diol | | | | |
| Antibacterial | LV(S) | 0.1 | 0.1 | 0.1 | 0.1 |
| agent | | | | | |
| Water | Deionized water | Balance | Balance | Balance | Balance |
| Total | | 100.0 | 100.0 | 100.0 | 100.0 |
| Ink | Concentration of | 7.0 | 6.0 | 5.0 | 4.0 |
| formulation | coloring material | | | | |
| Ink | Surface tension | 25.7 | 25.2 | 25.1 | 24.9 |
| properties | (mN/m) | | | | |
| Ink property | R/P | 0.32 | 0.32 | 0.32 | 0.31 |
| values | | | | | |
| Image | Single color (60 | A | A | A | A |
| quality | degrees gloss) | | | | |
| | Gloss uniformity | A | A | A | A |
| | Single color | B | B | A | A |
| | (fixability) | | | | |
| | Single color (image | A | A | A | B |
| | density) | | | | |
| Other | R/P value difference | 0.10 | 0.10 | 0.10 | 0.10 |
| property | among CMY | | | | |
| values | (maximum − | | | | |
| | minimum) | | | | |
| | Pig concentration | 2.0 | 1.0 | 0.0 | 1.0 |
| | difference among | | | | |
| | CMY | | | | |
| | R/P value average | 0.25 | 0.25 | 0.25 | 0.25 |
| | amount CMY | | | | |
| | Surface tension | −5.7 | −6.2 | −6.3 | −6.5 |
| | difference | | | | |
| | (minimum γ of | | | | |
| | colors − γ of black) | | | | |

TABLE 2

| | | M | M | M | M |
|---|---|---|---|---|---|
| | | Example | Example | Example | Example |
| | | M-5 | M-6 | M-7 | M-8 |
| Pigment | Black pigment | | | | |
| dispersion | dispersion | | | | |
| (pigment | (dispersant: | | | | |
| solids | compound of | | | | |
| content = 15 | Chemical Formula | | | | |
| percent) | 1) | | | | |
| | Blue pigment | | | | |
| | dispersion | | | | |
| | (dispersant: | | | | |
| | compound of | | | | |
| | Chemical Formula | | | | |
| | 2) | | | | |
| | Red pigment | | | | |
| | dispersion | | | | |
| | (dispersant: | | | | |
| | compound of | | | | |
| | Chemical Formula | | | | |
| | 2) | | | | |
| | Yellow pigment | | | | |
| | dispersion | | | | |
| | (dispersant: | | | | |
| | compound of | | | | |
| | Chemical Formula | | | | |
| | 2) | | | | |
| Resin-coated | Resin coated black | | | | |
| pigment | pigment dispersion | | | | |
| dispersion | Resin coated blue | | | | |
| (pigment | pigment dispersion | | | | |
| solids | Resin coated red | 33.3 | 33.3 | 33.3 | 33.3 |
| content = 15 | pigment dispersion | | | | |
| percent) | Resin coated yellow | | | | |
| | pigment dispersion | | | | |
| Coating resin | Styrene acrylic | 0.3 | 0.3 | 0.4 | 0.4 |
| | resin | | | | |
| Resin | Polyether urethane | 1.0 | 1.0 | 1.2 | 2.7 |
| particle | resin fine particle A | | | | |
| | (compound of | | | | |
| | Chemical Formula | | | | |
| | 7) | | | | |
| | Polyether urethane | | | | |
| | resin fine particle B | | | | |
| | (compound of | | | | |
| | Chemical Formula | | | | |
| | 7) | | | | |
| | Polyether urethane | | | | |
| | resin fine particle C | | | | |
| Surfactant | Silicone-based | 0.1 | 0.1 | 0.1 | 0.1 |
| | surfactant A | | | | |
| | (Chemical Formula | | | | |
| | 3) | | | | |
| | Silicone-based | | | | |
| | surfactant B | | | | |
| | (Chemical Formula | | | | |
| | 4) | | | | |
| | Acetylene-based | | | | |
| | surfactant | | | | |
| | (Chemical Formula | | | | |
| | 5) | | | | |
| | Alkyl-based | | | | |
| | surfactant | | | | |
| | (Chemical Formula | | | | |
| | 6) | | | | |
| | Fluorochemical | | | | |
| | (fluororesin) | | | | |
| | surfactant | | | | |
| Organic | Organic solvent A | 20.0 | 20.0 | 20.0 | 20.0 |
| solvent | Organic solvent B | 15.0 | 15.0 | 15.0 | 15.0 |
| Silicone oil | Polyether-modified | 0.1 | 0.1 | 0.1 | 0.1 |
| | silicone oil | | | | |
| Wax | Polyethylene wax | | 1.0 | 1.0 | 1.0 |
| Defoaming | 2,4,7,9-tetramethyl | 0.5 | 0.5 | 0.5 | 0.5 |
| agent | decane-4,7-diol | | | | |
| pH regulator | 2-amino-2-ethyl- | 0.5 | 0.5 | 0.5 | 0.5 |
| | 1,3-propane diol | | | | |
| Antibacterial | LV(S) | 0.1 | 0.1 | 0.1 | 0.1 |
| agent | | | | | |
| Water | Deionized water | Balance | Balance | Balance | Balance |
| Total | | 100.0 | 100.0 | 100.0 | 100.0 |
| Ink | Concentration of | 5.0 | 5.0 | 5.0 | 5.0 |
| formulation | coloring material | | | | |
| Ink | Surface tension | 24.8 | 25.1 | 25.4 | 24.2 |
| properties | (mN/m) | | | | |
| Ink property | R/P | 0.31 | 0.31 | 0.32 | 0.32 |
| values | | | | | |
| Image | Single color (60 | A | S | S | B |
| quality | degrees gloss) | | | | |
| | Gloss uniformity | A | A | A | B |
| | Single color | S | S | S | A |
| | (fixability) | | | | |
| | Single color (image | A | A | A | A |
| | density) | | | | |
| Other | R/P value | 0.10 | 0.10 | 0.10 | 0.10 |
| property | difference among | | | | |
| values | CMY (maximum − | | | | |
| | minimum) | | | | |
| | Pig concentration | 0.0 | 0.0 | 0.0 | 0.0 |
| | difference among | | | | |
| | CMY | | | | |
| | R/P value average | 0.25 | 0.25 | 0.25 | 0.25 |
| | amount CMY | | | | |
| | Surface tension | −6.6 | −6.3 | −6.0 | −7.2 |
| | difference | | | | |
| | (minimum γ of | | | | |
| | colors − γ of black) | | | | |
| | | M | M | M | M |
| | | Example | Example | Example | Example |
| | | M-9 | M-10 | M-11 | M-12 |
| Pigment | Black pigment | | | | |
| dispersion | dispersion | | | | |
| (pigment | (dispersant: | | | | |
| solids | compound of | | | | |
| content = 15 | Chemical Formula | | | | |
| percent) | 1) | | | | |
| | Blue pigment | | | | |
| | dispersion | | | | |
| | (dispersant: | | | | |
| | compound of | | | | |
| | Chemical Formula | | | | |
| | 2) | | | | |
| | Red pigment | | | | |
| | dispersion | | | | |
| | (dispersant: | | | | |
| | compound of | | | | |
| | Chemical Formula | | | | |
| | 2) | | | | |
| | Yellow pigment | | | | |
| | dispersion | | | | |
| | (dispersant: | | | | |
| | compound of | | | | |
| | Chemical Formula | | | | |
| | 2) | | | | |
| Resin-coated | Resin coated black | | | | |
| pigment | pigment dispersion | | | | |
| dispersion | Resin coated blue | | | | |
| (pigment | pigment dispersion | | | | |
| solids | Resin coated red | 53.3 | 33.3 | 33.3 | 33.3 |
| content = 15 | pigment dispersion | | | | |
| percent) | Resin coated yellow | | | | |
| | pigment dispersion | | | | |
| Coating resin | Styrene acrylic | 0.6 | 0.4 | 0.4 | 0.4 |
| | resin | | | | |
| Resin | Polyether urethane | 3.0 | 1.2 | 1.2 | 1.2 |
| particle | resin fine particle A | | | | |
| | (compound of | | | | |
| | Chemical Formula | | | | |
| | 7) | | | | |
| | Polyether urethane | | | | |
| | resin fine particle B | | | | |
| | (compound of | | | | |
| | Chemical Formula | | | | |
| | 7) | | | | |
| | Polyether urethane | | | | |
| | resin fine particle C | | | | |
| Surfactant | Silicone-based | 0.1 | | | |
| | surfactant A | | | | |
| | (Chemical Formula | | | | |
| | 3) | | | | |
| | Silicone-based | | 0.1 | | |
| | surfactant B | | | | |
| | (Chemical Formula | | | | |
| | 4) | | | | |
| | Acetylene-based | | | 0.1 | |
| | surfactant | | | | |
| | (Chemical Formula | | | | |
| | 5) | | | | |
| | Alkyl-based | | | | 0.1 |
| | surfactant | | | | |
| | (Chemical Formula | | | | |
| | 6) | | | | |
| | Fluorochemical | | | | |
| | (fluororesin) | | | | |
| | surfactant | | | | |
| Organic | Organic solvent A | 20.0 | 20.0 | 20.0 | 20.0 |
| solvent | Organic solvent B | 15.0 | 15.0 | 15.0 | 15.0 |
| Silicone oil | Polyether-modified | | | | |
| | silicone oil | | | | |
| Wax | Polyethylene wax | | | | |
| Defoaming | 2,4,7,9-tetramethyl | 0.5 | 0.5 | 0.5 | 0.5 |
| agent | decane-4,7-diol | | | | |
| pH regulator | 2-amino-2-ethyl- | 0.5 | 0.5 | 0.5 | 0.5 |
| | 1,3-propane diol | | | | |
| Antibacterial | LV(S) | 0.1 | 0.1 | 0.1 | 0.1 |
| agent | | | | | |
| Water | Deionized water | Balance | Balance | Balance | Balance |
| Total | | 100.0 | 100.0 | 100.0 | 100.0 |
| Ink | Concentration of | 8.0 | 5.0 | 5.0 | 5.0 |
| formulation | coloring material | | | | |
| Ink | Surface tension | 24.8 | 26.1 | 25.8 | 25.5 |
| properties | (mN/m) | | | | |
| Ink property | R/P | 0.45 | 0.32 | 0.32 | 0.32 |
| values | | | | | |
| Image | Single color (60 | B | A | A | A |
| quality | degrees gloss) | | | | |
| | Gloss uniformity | B | A | A | A |
| | Single color | A | A | A | A |
| | (fixability) | | | | |
| | Single color (image | S | A | A | A |
| | density) | | | | |
| Other | R/P value | 0.24 | 0.10 | 0.10 | 0.10 |
| property | difference among | | | | |
| values | CMY (maximum − | | | | |
| | minimum) | | | | |
| | Pig concentration | 3.0 | 0.0 | 0.0 | 0.0 |
| | difference among | | | | |
| | CMY | | | | |
| | R/P value average | 0.30 | 0.25 | 0.25 | 0.25 |
| | amount CMY | | | | |
| | Surface tension | −6.6 | −5.3 | −5.6 | −5.9 |
| | difference | | | | |
| | (minimum γ of | | | | |
| | colors − γ of black) | | | | |
| | | M | M | M | M |
| | | Example | Example | Example | Example |
| | | M-13 | M-14 | M-15 | M-16 |
| Pigment | Black pigment | | | | |
| dispersion | dispersion | | | | |
| (pigment | (dispersant: | | | | |
| solids | compound of | | | | |
| content = 15 | Chemical Formula | | | | |
| percent) | 1) | | | | |
| | Blue pigment | | | | |
| | dispersion | | | | |
| | (dispersant: | | | | |
| | compound of | | | | |
| | Chemical Formula | | | | |
| | 2) | | | | |
| | Red pigment | | | | |
| | dispersion | | | | |
| | (dispersant: | | | | |
| | compound of | | | | |
| | Chemical Formula | | | | |
| | 2) | | | | |
| | Yellow pigment | | | | |
| | dispersion | | | | |
| | (dispersant: | | | | |
| | compound of | | | | |
| | Chemical Formula | | | | |
| | 2) | | | | |
| Resin-coated | Resin coated black | | | | |
| pigment | pigment dispersion | | | | |
| dispersion | Resin coated blue | | | | |
| (pigment | pigment dispersion | | | | |
| solids | Resin coated red | 33.3 | 33.3 | 33.3 | 33.3 |
| content = 15 | pigment dispersion | | | | |
| percent) | Resin coated yellow | | | | |
| | pigment dispersion | | | | |
| Coating resin | Styrene acrylic | 0.4 | 0.4 | 0.4 | 0.4 |
| | resin | | | | |
| Resin | Polyether urethane | 1.2 | | | 1.2 |
| particle | resin fine particle A | | | | |
| | (compound of | | | | |
| | Chemical Formula | | | | |
| | 7) | | | | |
| | Polyether urethane | | 1.2 | | |
| | resin fine particle B | | | | |
| | (compound of | | | | |
| | Chemical Formula | | | | |
| | 7) | | | | |
| | Polyether urethane | | | 1.2 | |
| | resin fine particle C | | | | |
| Surfactant | Silicone-based | | 0.1 | 0.1 | 0.05 |
| | surfactant A | | | | |
| | (Chemical Formula | | | | |
| | 3) | | | | |
| | Silicone-based | | | | |
| | surfactant B | | | | |
| | (Chemical Formula | | | | |
| | 4) | | | | |
| | Acetylene-based | | | | |
| | surfactant | | | | |
| | (Chemical Formula | | | | |
| | 5) | | | | |
| | Alkyl-based | | | | |
| | surfactant | | | | |
| | (Chemical Formula | | | | |
| | 6) | | | | |
| | Fluorochemical | 0.1 | | | |
| | (fluororesin) | | | | |
| | surfactant | | | | |
| Organic | Organic solvent A | 20.0 | 20.0 | 20.0 | 20.0 |
| solvent | Organic solvent B | 15.0 | 15.0 | 15.0 | 15.0 |
| Silicone oil | Polyether-modified | | | | |
| | silicone oil | | | | |
| Wax | Polyethylene wax | | | | |
| Defoaming | 2,4,7,9-tetramethyl | 0.5 | 0.5 | 0.5 | 0.5 |
| agent | decane-4,7-diol | | | | |
| pH regulator | 2-amino-2-ethyl- | 0.5 | 0.5 | 0.5 | 0.5 |
| | 1,3-propane diol | | | | |
| Antibacterial | LV(S) | 0.1 | 0.1 | 0.1 | 0.1 |
| agent | | | | | |
| Water | Deionized water | Balance | Balance | Balance | Balance |
| Total | | 100.0 | 100.0 | 100.0 | 100.0 |
| Ink | Concentration of | 5.0 | 5.0 | 5.0 | 5.0 |
| formulation | coloring material | | | | |
| Ink | Surface tension | 24.2 | 25.3 | 26.0 | 29.0 |
| properties | (mN/m) | | | | |
| Ink property | R/P | 0.32 | 0.32 | 0.32 | 0.32 |
| values | | | | | |
| Image | Single color (60 | B | A | B | B |
| quality | degrees gloss) | | | | |
| | Gloss uniformity | B | A | B | B |
| | Single color | A | A | B | B |
| | (fixability) | | | | |
| | Single color (image | A | A | A | A |
| | density) | | | | |
| Other | R/P value | 0.10 | 0.10 | 0.10 | 0.10 |
| property | difference among | | | | |
| values | CMY (maximum − | | | | |
| | minimum) | | | | |
| | Pig concentration | 0.0 | 0.0 | 0.0 | 0.0 |
| | difference among | | | | |
| | CMY | | | | |
| | R/P value average | 0.25 | 0.25 | 0.25 | 0.25 |
| | amount CMY | | | | |
| | Surface tension | −7.2 | −6.1 | −5.4 | −3.0 |
| | difference | | | | |
| | (minimum γ of | | | | |
| | colors − γ of black) | | | | |

The aspects of the present disclosure are, for example, as follows:

### Aspect 1

An ink set contains a black ink, a cyan ink, a magenta ink, and a yellow ink, each ink of the black ink, the cyan ink, the magenta ink, and the yellow ink independently containing a coloring material. a water-soluble organic solvent, a resin particle, and water,
each of the black ink, the cyan ink, and the yellow ink independently containing the following (A) or a combination of (A) and the following (B), and
the magenta ink containing (B),
(A) a compound represented by the Chemical Formula 1 below or the Chemical Formula 2 below;

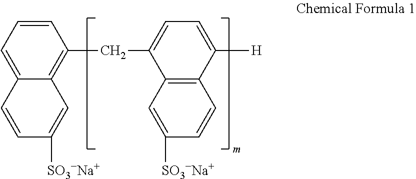

where, m represents an integer of from 1 to 4,

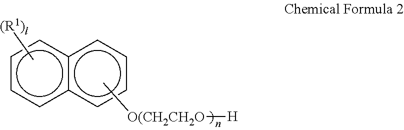

where, R¹ represents an alkyl group having 1 to 20 carbon atoms, an aralkyl group having 7 or 8 carbon atoms, or an ally group, 1 represents 0 or an integer of from 1 to 7, and n represents an integer of from 20 to 200,
(B) the coloring material including a coloring material at least partially coated with a water-insoluble resin,
wherein an R/P value of the magenta ink is the largest of the R/P value of each ink, where R represents a concentration of the resin particle in each ink and P represents a concentration of the coloring material in each ink,
wherein the following relationship is satisfied:

0.10≤the maximum R/P value of the cyan ink, the magenta ink, and the yellow ink−the minimum R/P value of the cyan ink, the magenta ink, and the yellow ink≤0.40.

### Aspect 2

The ink set according to Aspect 1 mentioned above, wherein the difference between the maximum and the minimum of the concentration of the coloring material in the cyan ink, the magenta ink, and the yellow ink is at most 2 percent by mass.

### Aspect 3

The ink set according to Aspect 1 or 2 mentioned above, wherein the average of the RP values of the cyan ink, the magenta ink, and the yellow ink is 0.25 to 0.35.

### Aspect 4

The ink set according to any one of Aspects 1 to 3 mentioned above, wherein each ink further contains a silicone-based compound represented by the following Chemical Formula 3 or 4, an acetylene-based compound represented by the following Chemical Formula 5, and a polyoxyethylene alkyl ether-based compound represented by the following Chemical Formula 6:

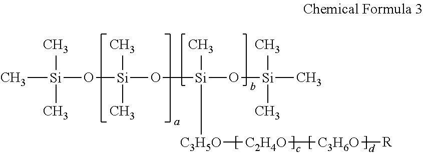

where a represents 0 or an integer of from 1 to 23, b represents an integer of from 1 to 10, c represents an integer of from 1 to 23, d represents 0 or an integer of from 1 to 23, and R represents a hydrogen atom or an alkyl group having 1 to 4 carbon atoms:

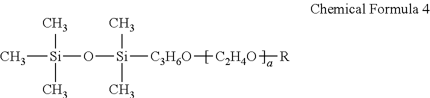

where a represents an integer of from 1 to 8 and R represents a hydrogen atom or an alkyl group having 1 to 4 carbon atoms:

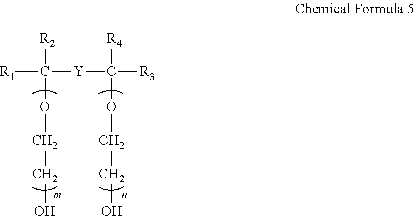

where R₁ to R₄ each independently represent alkyl groups, m+n represents an integer of from 1 to 20, and Y represents an acetylene group:

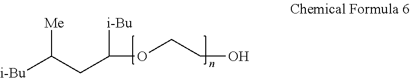

where, n represents an integer of from 8 to 12.

### Aspect 5

The ink set according to any one of Aspects 1 to 4 mentioned above, wherein each ink further contains a polyether-based urethane resin represented by the following Chemical Formula 7:

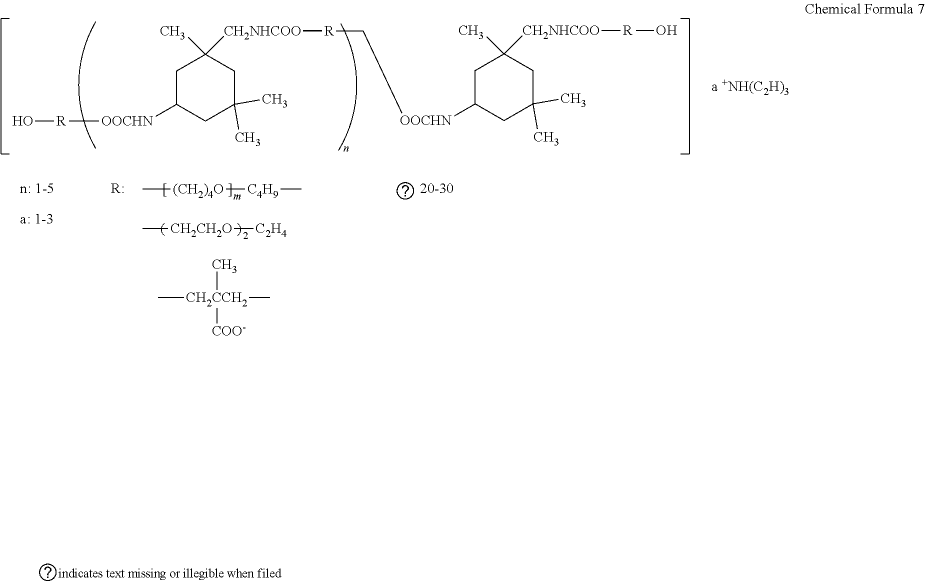

### Aspect 6

The ink set according to Aspect 5 mentioned above, wherein the polyether-based urethane resin has an acid value of from 48 to 80 KOHmg/g.

### Aspect 7

The ink set according to any one of Aspects 1 to 6 mentioned above, wherein each ink further contains a silicone oil.

### Aspect 8

The ink set according to any one of Aspects 1 to 7 mentioned above, wherein each ink further contains a polyethylene wax.

### Aspect 9

The ink according to any one of Aspects 1 to 8 mentioned above, wherein the water-insoluble resin contains a styrene acrylic resin.

### Aspect 10

The ink set according to any one of Aspects 1 to 9 mentioned above, wherein each of the cyan ink, the magenta ink, and the yellow ink independently has a surface tension at least 3.0 mN/m less than that of the black ink.

### Aspect 11

A printing apparatus contains the ink set of any one of Aspects 1 to 10 mentioned above and an inkjet head that includes a nozzle to discharge each ink and a nozzle plate having an ink repulsion layer containing a silicone resin or a fluororesin on the surface on the ink discharging side.

### Aspect 12

A printing method includes discharging each ink of the ink set of any one of Aspects 1 to 10 mentioned above with an inkjet head that includes a nozzle for discharging each ink and a nozzle plate having an ink repulsion layer containing a silicone resin or a fluororesin on the surface on the ink discharging side.

### Aspect 13

The printing method according to Aspect 12 mentioned above, wherein the discharging includes discharging the cyan ink, the magenta ink, the yellow ink, without discharging the black ink, to form a black image.

The above-described embodiments are illustrative and do not limit the present invention. Thus, numerals additional modifications and variations are possible in light of the above-teachings. For example, elements and/or features of difference illustrative embodiments may be combined with each other and/or substituted for each other within the scope of the present invention. Any one of the above-described operations may be performed in various other ways, for example, in an order difference from the one described above.

1. An ink set comprising:
a black ink;
a cyan ink;
a magenta ink; and
a yellow ink,
each ink of the black ink, the cyan ink, the magenta ink, and the yellow ink independently comprising a coloring material. a water-soluble organic solvent, a resin particle, and water,
each of the black ink, the cyan ink, and the yellow ink independently comprising the following (A) or a combination of (A) and the following (B), and
the magenta ink comprising (B),
(A) a compound represented by the Chemical Formula 1 below or the Chemical Formula 2 below; 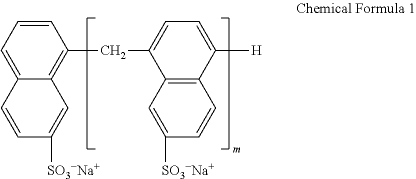
where, m represents an integer of from 1 to 4, 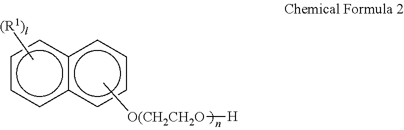
where, R¹ represents an alkyl group having 1 to 20 carbon atoms, an aralkyl group having 7 or 8 carbon atoms, or an ally group, 1 represents 0 or an integer of from 1 to 7, and n represents an integer of from 20 to 200,
(B) the coloring material including a coloring material at least partially coated with a water-insoluble resin,
wherein an R/P value of the magenta ink is the largest of the R/P value of the each ink, where R represents a concentration of the resin particle in the each ink and P represents a concentration of the coloring material in the each ink,
wherein the following relationship is satisfied:
0.10≤the maximum R/P value of the cyan ink, the magenta ink, and the yellow ink−the minimum R/P value of the cyan ink, the magenta ink, and the yellow ink≤0.40.

2. The ink set according to claim 1,
wherein a difference between the maximum and the minimum of the concentration of the coloring material of each of the cyan ink, the magenta ink, and the yellow ink is at most 2 percent by mass.

3. The ink set according to claim 1, wherein an average of the RP values of the cyan ink, the magenta ink, and the yellow ink is 0.25 to 0.35.

4. The ink set according to claim 1,
wherein the each ink further comprises a silicone-based compound represented by the following Chemical Formula 3 or 4, an acetylene-based compound represented by the following Chemical Formula 5, and a polyoxyethylene alkyl ether-based compound represented by the following Chemical Formula 6: 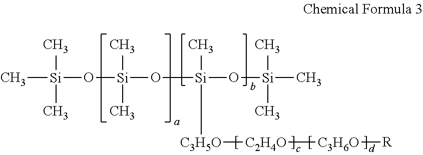
where a represents 0 or an integer of from 1 to 23, b represents an integer of from 1 to 10, c represents an integer of from 1 to 23, d represents 0 or an integer of from 1 to 23, and R represents a hydrogen atom or an alkyl group having 1 to 4 carbon atoms: 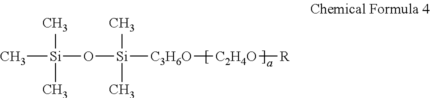
where a represents an integer of from 1 to 8 and R represents a hydrogen atom or an alkyl group having 1 to 4 carbon atoms: 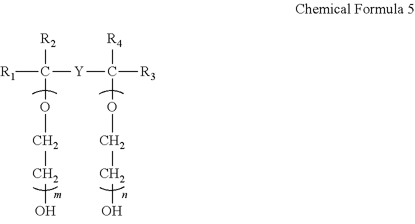
where R₁ to R₄ each independently represent alkyl groups, m+n represents an integer of from 1 to 20, and Y represents an acetylene group: 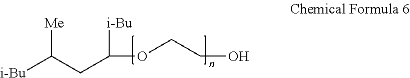
where, n represents an integer of from 8 to 12.

5. The ink set according to claim 1,
wherein the each ink further comprises a polyether-based urethane resin represented by the following Chemical Formula 7:

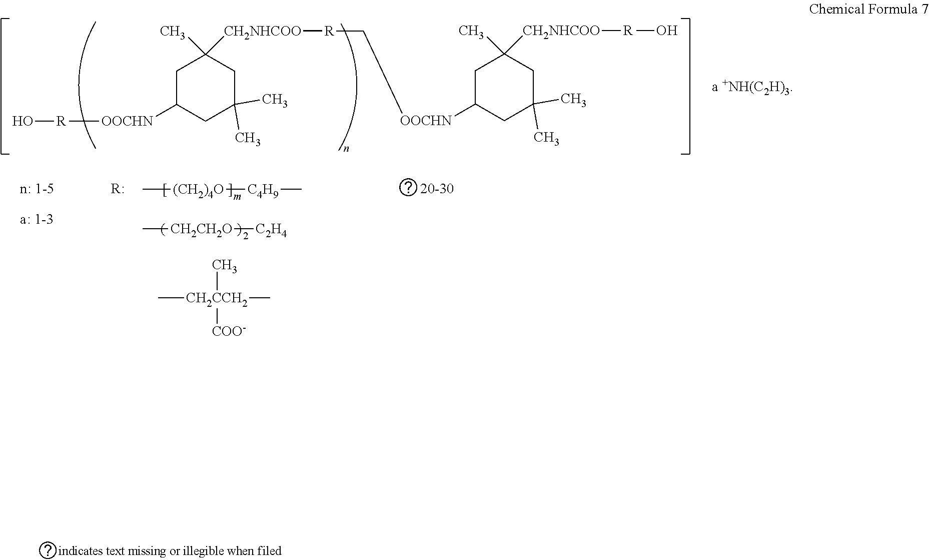

6. The ink set according to claim 5,
wherein the polyether-based urethane resin has an acid value of from 48 to 80 KOHmg/g.

7. The ink set according to claim 1,
wherein the each ink further comprises a silicone oil.

8. The ink set according to claim 1,
wherein the each ink further comprises a polyethylene wax.

9. The ink according to claim 1,
wherein the water-insoluble resin comprises a styrene acrylic resin.

10. The ink set according to claim 1,
wherein each of the cyan ink, the magenta ink, and the yellow ink independently has a surface tension at least 3.0 mN/in less than that of the black ink.

11. A printing apparatus comprising:
the ink set of claim 1; and
an inkjet head comprising:
a nozzle to discharge the each ink; and
a nozzle plate having an ink repulsion layer containing a silicone resin or a fluororesin on a surface on an ink discharging side.

12. A printing method comprising:
a nozzle to discharge the each ink; and
a nozzle plate having an ink repulsion layer containing a silicone resin or a fluororesin on a surface on an ink discharging side.

13. The printing method according to claim 12,
wherein the discharging includes discharging the cyan ink, the magenta ink, the yellow ink, without discharging the black ink, to form a black image.
